(19) United States
(12) Patent Application Publication
(10) Pub. No.: US 2011/0008522 A1
(43) Pub. Date: Jan. 13, 2011

(54) Full-Fat Soybean Flour-Containing Composition, and Egg Substitute Composition

(75) Inventors: Akemi Satou, Tokyo (JP); Haruna Aida, Kanagawa (JP); Miki Murakami, Kanagawa (JP)

Correspondence Address: FISH & RICHARDSON P.C. (DC), P.O. BOX 1022, MINNEAPOLIS, MN, 55440-1022, US

(73) Assignee: THE NISSHIN OILLIO GROUP, LTD., Tokyo (JP)

(21) Appl. No.: 12/878,670

(22) Filed: Sep. 9, 2010

Related U.S. Application Data
(63) Continuation of application No. PCT/JP2009/054865, filed on Mar. 13, 2009.

(30) Foreign Application Priority Data
Mar. 13, 2008 (JP) 2008-064865

(51) Int. Cl. A23L 1/20

(52) U.S. Cl. 426/634

(57) ABSTRACT

A full-fat soybean flour-containing composition which is capable of improving flavor and texture of foods by using as a substitute for a part or the entirety of a basic ingredient of a food, or by additionally using as a novel basic ingredient, and a food prepared using the same are provided. In addition, an egg substitute composition which can be used in a food as an egg substitute and which contains a full-fat soybean flour as a principal component, and a food prepared using the same are provided. The full-fat soybean flour-containing composition of the present invention contains a full-fat soybean flour, a plant protein, an emulsifying agent, and a masking agent. Moreover, the egg substitute composition of the present invention contains a full-fat soybean flour, a plant protein, an emulsifying agent, and a masking agent, and can be used in a food as an egg substitute.

This application is a continuation of International Application Serial No. PCT/JP2009/054865, filed Mar. 13, 2009, and claims benefit of priority of Japanese Patent Application No. 2008-064865, filed on Mar. 13, 2008. The disclosures of the prior applications are considered part of the disclosure of this application and are herein incorporated by reference.

### BACKGROUND OF THE INVENTION

1. Field of the Invention

The present invention relates to a full-fat soybean flour-containing composition and an egg substitute composition, and a food prepared using the same.

2. Related Art

Conventionally, soybeans have been consumed as Japanese traditional processed foods such as soybean curd (tofu) and fermented soybean (natto); however, as health consciousness increases in recent years, bioactive effects of high-quality proteins included in soybeans in a large amount, as well as minor components such as lecithins, saponins, isoflavones and oligosaccharides have attracted attention, and thus their applicable field has been growing. Soybean flour prepared by powderizing soybeans has been utilized in various types of processed foods, and for example, Patent Document 1 discloses cookies in which soybean fine powders are used as a substitute for wheat flour. According to this Document, unique flavor and texture of cookies are not impaired even if wheat flour is not used, and further amelioration effects exerted by soybean proteins on elevated cholesterol can be expected.

On the other hand, eggs have been utilized in a variety of foods since they have characteristic features superior in nutritional value, flavor, function, etc. In particular, production of baked foods such as cakes and breads greatly depends on contribution from flavor and function of the egg. However, since eggs are likely to go rotten, they cannot be stored for a long period of time, and there is a restriction in use thereof due to the necessity of troublesome operations such as breaking of the eggs and disposal of the egg shells. Furthermore, there is concern regarding the use of eggs with respect to health due to features such as being a candidate for an allergic factor, containing a large amount of cholesterol and saturated fatty acids, having possibility of contamination with salmonella bacteria, and the like.

Under such circumstances, there exist demands for foods prepared without using eggs, and production methods of a variety of such foods have been investigated. For example, a method for producing a sponge cake using an isolated whey protein as an egg substitute was reported (see, Patent Document 2).

Patent Document 1: Japanese Patent No. 3701281

Patent Document 2: Japanese Unexamined Patent Application, Publication No. H2-42942

### SUMMARY OF THE INVENTION

However, there is still room for further improvement of foods prepared using full-fat soybean flour without modification in terms of flavor and texture of the foods. In addition, although an isolated whey protein may serve as an egg substitute, there has been restriction in production due to the necessity for giving higher purity using an adsorptive resin according to an ion exchange method.

Thus, an object of the present invention is to provide a full-fat soybean flour-containing composition, which is capable of improving flavor and texture of foods by using as a substitute for a part or the entirety of a basic ingredient of a food, or by additionally using as a novel basic ingredient, and a food prepared using the same. In addition, a further object of the present invention is to provide an egg substitute composition which can be used in foods as an egg substitute and which contains a full-fat soybean flour as a principal component, and a food prepared using the same.

The present inventors thoroughly investigated in order to solve the foregoing problems, and as a result, found that use of a full-fat soybean flour-containing composition as a principal component in place of a part or the entirety of a basic ingredient of a food, or additional use thereof as a novel basic ingredient improves flavor and texture of the food. Accordingly, the present invention was completed. More specifically, the present invention provides as in the following.

A first aspect of the present invention provides a full-fat soybean flour-containing composition containing a full-fat soybean flour, a plant protein, an emulsifying agent, and a masking agent.

A second aspect of the present invention provides the full-fat soybean flour-containing composition according to the first aspect, wherein the plant protein is at least one selected from the group consisting of a wheat protein and a soybean protein.

A third aspect of the present invention provides the full-fat soybean flour-containing composition according to the first or second aspect, wherein the content of the emulsifying agent in the full-fat soybean flour-containing composition is no less than 1% by mass and less than 5% by mass, and the content of the masking agent is greater than 1.5% by mass and no greater than 20% by mass.

A fourth aspect of the present invention provides the full-fat soybean flour-containing composition according to any one of the first to third aspects, wherein the component contained in the largest amount in the full-fat soybean flour-containing composition is the full-fat soybean flour.

A fifth aspect of the present invention provides the full-fat soybean flour-containing composition according to any one of the first to fourth aspects, wherein the content of the full-fat soybean flour in the full-fat soybean flour-containing composition is 40 to 90% by mass.

A sixth aspect of the present invention provides the full-fat soybean flour-containing composition according to any one of the first to fifth aspects, wherein the total content of the full-fat soybean flour and the plant protein in the full-fat soybean flour-containing composition is 65 to 97% by mass.

A seventh aspect of the present invention provides the full-fat soybean flour-containing composition according to any one of the first to sixth aspects, further containing at least one selected from the group consisting of a plant starch and a rice flour.

An eighth aspect of the present invention provides the full-fat soybean flour-containing composition according to the seventh aspect, wherein the content of the at least one selected from the group consisting of the plant starch and the rice flour in the full-fat soybean flour-containing composition is no greater than 30% by mass.

A ninth aspect of the present invention provides the full-fat soybean flour-containing composition according to the seventh or eighth aspect, wherein the total content of the full-fat soybean flour and the plant protein, and the at least one selected from the group consisting of the plant starch and the rice flour in the full-fat soybean flour-containing composition is 70 to 95% by mass.

A tenth aspect of the present invention provides a food prepared using the full-fat soybean flour-containing composition according to any one of the first to ninth aspects.

An eleventh aspect of the present invention provides the food according to the tenth aspect, wherein the food is one selected from the group consisting of a baked food, a fried-in-oil food, a steamed food, a noodle strip food, a gelatinous fresh confectionery, a fried-rolled egg (tamagoyaki), a flour for deep-fried food (tempura), and a batter.

A twelfth aspect of the present invention provides the food according to the tenth aspect, wherein the food is a rolled cake not containing any of a wheat flour and milk.

A thirteenth aspect of the present invention provides the food according to the tenth aspect, wherein the food is a deep-fried confectionery not containing any of a wheat flour, milk, and egg.

A fourteenth aspect of the present invention provides an egg substitute composition containing a full-fat soybean flour, a plant protein, an emulsifying agent, and a masking agent.

A fifteenth aspect of the present invention provides the egg substitute composition according to the fourteenth aspect, wherein the plant protein is at least one selected from the group consisting of a wheat protein and a soybean protein.

A sixteenth aspect of the present invention provides the egg substitute composition according to the fourteenth or fifteenth aspect, wherein the content of the emulsifying agent in the egg substitute composition is no less than 1% by mass and less than 5% by mass, and the content of the masking agent is greater than 1.5% by mass and no greater than 20% by mass.

A seventeenth aspect of the present invention provides the egg substitute composition according to any one of the fourteenth to sixteenth aspects, wherein the component contained in the largest amount in the egg substitute composition is the full-fat soybean flour.

An eighteenth aspect of the present invention provides the egg substitute composition according to any one of the fourteenth to seventeenth aspects, wherein the content of the full-fat soybean flour in the egg substitute composition is 40 to 90% by mass.

A nineteenth aspect of the present invention provides the egg substitute composition according to any one of the fourteenth to eighteenth aspects, wherein the total content of the full-fat soybean flour and the plant protein in the egg substitute composition is 65 to 97% by mass.

A twentieth aspect of the present invention provides the egg substitute composition according to any one of the fourteenth to nineteenth aspects, further containing at least one selected from the group consisting of a plant starch and a rice flour.

A twenty first aspect of the present invention provides the egg substitute composition according to the twentieth aspect, wherein the content of the at least one selected from the group consisting of the plant starch and the rice flour in the egg substitute composition is no greater than 30% by mass.

A twenty second aspect of the present invention provides the egg substitute composition according to the twentieth or twenty first aspect, wherein the total content of the full-fat soybean flour and the plant protein, and the at least one selected from the group consisting of the plant starch and the rice flour in the egg substitute composition is 70 to 95% by mass.

A twenty third aspect of the present invention provides a food prepared using the egg substitute composition according to any one of the fourteenth to twenty second aspects.

A twenty fourth aspect of the present invention provides the food according to the twenty third aspect, wherein the food is one selected from the group consisting of a baked food, a fried-in-oil food, a steamed food, a gelatinous fresh confectionery, a tamagoyaki, and a batter.

A twenty fifth aspect of the present invention provides the food according to the twenty third aspect, wherein the food is one selected from the group consisting of a baked food, a fried-in-oil food, a steamed food, a gelatinous fresh confectionery and a batter, and does not contain egg.

A twenty sixth aspect of the present invention provides the food according to the twenty third aspect, wherein the food is a steamed bread not containing any of egg, a wheat flour and milk.

According to the full-fat soybean flour-containing composition of the present invention, flavor and texture of foods can be improved by using the composition as a substitute for a part or the entirety of a basic ingredient of a food, or by additionally using the same as a novel basic ingredient. In addition, according to the egg substitute composition of the present invention, use of the composition as an egg substitute in a food, particularly in a baked food can impart to the food leavening and rich flavor comparative to the level achieved when an egg was used, without using an egg.

### BRIEF DESCRIPTION OF THE DRAWINGS

FIG. 1 shows a view illustrating results of measuring with a rheometer the hardness of Japanese wheat noodle (udon) produced using the full-fat soybean flour-containing composition of the present invention.

### DETAILED DESCRIPTION OF THE INVENTION

Hereinafter, each constitution of the present invention is explained in detail.

### Full-Fat Soybean Flour-Containing Composition

The full-fat soybean flour-containing composition of the present invention is characterized by containing a full-fat soybean flour, a plant protein, an emulsifying agent, and a masking agent.

In the full-fat soybean flour-containing composition of the present invention, a full-fat soybean flour is blended for the purpose of enhancing the nutritional additional value, and improving the flavor and texture of the food prepared using such a full-fat soybean flour-containing composition.

Soybeans contain not only high-quality proteins in a large amount, but also functional substances such as soybean lecithin that reduces total cholesterol, oligosaccharides having an action to proliferate bifidobacteria, soybean saponins expected to be capable of lowering blood lipids, and isoflavones reportedly capable of preventing osteoporosis. Since the full-fat soybean flour-containing composition of the present invention contains a full-fat soybean flour obtained by grinding to powderize soybeans as a whole, all the aforementioned functional substances are included, and has a superior nutritional value.

As the source material of the full-fat soybean flour, commercially available dried soybeans may be used. For example, any one of domestically produced soybeans such as Enrei, Ryuho, Toyohomare and Miyagishirome, and foreign soybeans such as IOM can be used, which may be either genetically modified, or ungenetically modified. Since the soybean is full-fat, it is not obtained from a defatted soybean, generally referred to, as a basic ingredient. Since a soybean flour is used, it is different from “soybean protein” generally referred to. The production method is not particularly limited, and the soybeans as a whole may be ground to permit powderization, or the whole soybean milk may be prepared which may be subsequently subjected to drying and powderization. Moreover, the soybean which may be used is either unsprouted or sprouted. It should be noted that the sprouted full-fat soybean flour also functions as a masking agent as described later.

In the full-fat soybean flour-containing composition of the present invention, the content of the full-fat soybean flour is not particularly limited, and may be adjusted ad libitum in the range enabling the effects of the present invention to be exhibited. However, the content of the full-fat soybean flour contained in the full-fat soybean flour-containing composition is preferably 40 to 90% by mass, and more preferably 45 to 85% by mass. In the full-fat soybean flour-containing composition, it is preferred that the full-fat soybean flour is contained in the largest amount, in light of the nutritional additional value.

In the full-fat soybean flour-containing composition of the present invention, a plant protein is blended for the purpose of improving the texture, anti-aging, and maintaining the water holding capacity of the food prepared using the full-fat soybean flour-containing composition, and particularly for imparting leavening to baked foods and steamed foods.

The plant protein to be contained in the full-fat soybean flour-containing composition of the present invention is not particularly limited as long as it imparts leavening to baked foods and steamed foods. For example, a wheat protein, a soybean protein, a fava bean protein, a garden pea protein, and the like may be exemplified, and these may be used alone, or two or more thereof may be used in combination. Among these, a wheat protein and a soybean protein are preferred in light of the versatility, and these are preferably used either alone, or in combination.

Although the content of the plant protein in the full-fat soybean flour-containing composition of the present invention is not particularly limited, the content is preferably 0.1 to 25% by mass, more preferably 1 to 20% by mass, and still more preferably 5 to 20% by mass. When the content falls within such a range, effects of improving the texture, anti-aging, maintaining water holding capacity, as well as imparting leavening to baked foods and steamed foods, and the like can be achieved.

The full-fat soybean flour-containing composition of the present invention contains an emulsifying agent. The emulsifying agent contained in the full-fat soybean flour-containing composition of the present invention is not particularly limited, and a conventionally well-known emulsifying agent may be used. Examples of the emulsifying agent include various types of organic acid monoglycerides such as soybean lecithin, sucrose fatty acid esters, propylene glycol fatty acid esters, sorbitan fatty acid esters, glycerin fatty acid esters, polyglycerin fatty acid esters, acetic acid monoglycerides, tartaric acid monoglycerides, citric acid monoglycerides and lactic acid monoglycerides, and these may be used alone, or two or more thereof may be used in combination. Alternatively, products generally on the market may be used.

A masking agent is contained in the full-fat soybean flour-containing composition of the present invention for the purpose of suppressing a flavor peculiar to the emulsifying agent which can be generated when such a full-fat soybean flour-containing composition is used, and gluten odor generated when a wheat protein is used as the plant protein to improve the flavor of the food.

The masking agent to be contained in the full-fat soybean flour-containing composition of the present invention is not particularly limited, and a conventionally well-known masking agent may be used. Examples of the masking agent include trehalose, dextrin, highly branched cyclic dextrin, cyclodextrin, sprouted full-fat soybean powders subjected to an enzyme-deactivating treatment and the like, and these may be used alone, or two or more thereof may be used in combination. Among these, it is more preferred that trehalose or highly branched cyclic dextrin having less smell peculiar to the masking agent itself be used. By using trehalose and highly branched cyclic dextrin in combination, the flavor of the food can be further improved.

The sprouted full-fat soybean powders can be produced by, for example, the following method. Water is added to sprouted soybeans obtained by carrying out a sprouting treatment, followed by grinding to give a bean homogenate. Next, thus obtained bean homogenate is subjected to an enzyme-deactivating treatment, and thus an enzyme-deactivated, sprouted whole soybean milk is obtained. Thereafter, such a sprouted whole soybean milk is dried by spray drying to produce an enzyme-deactivated and sprouted full-fat soybean powders. It is to be noted that production method of the sprouted full-fat soybean powders is not limit to the aforementioned method, and the sprouted soybean as a whole may be pulverized to permit powderization.

In the full-fat soybean flour-containing composition of the present invention, the contents of the emulsifying agent and the masking agent are not particularly limited, but it is preferred that the content of the emulsifying agent in the full-fat soybean flour-containing composition be no less than 1% by mass and less than 5% by mass, and the content of the masking agent be greater than 1.5% by mass and no greater than 20% by mass. Herein, the content of the emulsifying agent is more preferably 1 to 4% by mass, and still more preferably 1 to 3% by mass. When the content of the emulsifying agent is no less than 5% by mass, a strong odor of the emulsifying agent may be generated. Moreover, the content of the masking agent is more preferably 3 to 20% by mass, and still more preferably 4 to 15% by mass. When the content of the masking agent is no greater than 1.5% by mass, expected effects may not be exhibited depending on the contents of the emulsifying agent, the plant protein, and the soybean flour in the full-fat soybean flour-containing composition.

In the full-fat soybean flour-containing composition of the present invention, the total content of the full-fat soybean flour and the plant protein is not particularly limited, and may be adjusted ad libitum in the range enabling the effects of the present invention to be exhibited. The total content is preferably 65 to 97% by mass, more preferably 65 to 90% by mass, still more preferably 65 to 85% by mass, and even more preferably 70 to 85% by mass.

It is preferred that the full-fat soybean flour-containing composition of the present invention further contains at least one selected from the group consisting of a plant starch and a rice flour so that a favorable texture can be imparted to the food prepared using such a full-fat soybean flour-containing composition. Particularly, in the case of baked foods and steamed foods, favorable leavening can be achieved by containing the plant starch and/or the rice flour.

The plant starch which may be contained in the full-fat soybean flour-containing composition of the present invention is not particularly limited, and for example, rice flour starch, wheat starch, maize starch, potato starch, tapioca starch, sweetpotato starch, red bean (azuki) starch, green bean starch, puerariae radix (kudzu) starch, Dogtooth violet (katakuri) starch, and the like may be exemplified. Of these, potato starch is preferably used, and in particular, use of raw potato starch and crosslinked potato starch in combination is preferable in light of improvement of the flavor of the food, improvement of the texture, and assists for leavening of the baked foods and steamed foods. The aforementioned plant starch may be used either alone, or as any combination of two or more thereof. When a soybean protein or the like that is believed to have inferior puffing characteristics as compared with wheat proteins is contained, to contain the plant starch and/or the rice flour is particularly preferred for fulfilling the leavening.

The content of the plant starch and/or the rice flour in the full-fat soybean flour-containing composition of the present invention is not particularly limited, but the upper limit is preferably no greater than 30% by mass, more preferably no greater than 25% by mass, and still more preferably no greater than 20% by mass. The lower limit is preferably no less than 3% by mass, and more preferably no less than 5% by mass. Still more preferably, the content of the plant starch and/or the rice flour is 5 to 20% by mass. When the content falls within this range, flavor and texture of foods can be further improved in light of the balance in blending with the full-fat soybean flour.

Herein, the total amount of the full-fat soybean flour and the plant protein, and the at least one selected from the group consisting of the plant starch and the rice flour in the full-fat soybean flour-containing composition of the present invention containing the plant starch and/or the rice flour is not particularly limited, and can be adjusted ad libitum in the range enabling the effects of the present invention to be exhibited. The total content of the full-fat soybean flour and the plant protein, and the at least one selected from the group consisting of the plant starch and the rice flour is preferably 70 to 95% by mass.

In addition, the full-fat soybean flour-containing composition of the present invention may further contain food additives such as a corn flour, a nutrient component, a stabilizer, a preservative, a sweetener, a flavor, a colorant and an anti-oxidizing agent to meet the intended object. Furthermore, an excipient, a bulking filler and the like well-known in the art may be contained as needed. For example, for the purpose of changing the texture, a physical property improving agent such as sodium L-ascorbate may be also used.

The food of the present invention is characterized in that it is prepared using the aforementioned full-fat soybean flour-containing composition. The full-fat soybean flour-containing composition of the present invention can be used in any foods, and may be used as a substitute for a part or the entirety of a basic ingredient of a food, or as an additional novel basic ingredient. The food may be, for example, a baked food, a fried-in-oil food, a steamed food, a noodle strip food, a gelatinous fresh confectionery, a tamagoyaki, a flour for tempura, a batter, or the like.

The baked food referred to herein means a food prepared by forming and baking a dough including the full-fat soybean flour-containing composition described above as a principal component, and may be exemplified by baked confectioneries, breads, pastries, and the like. Examples of the baked confectionery include sponge cakes, pound cakes, tube cakes (chiffon cake), pancakes, rolled cakes, castellas, doughnuts, madeleines, biscuits, cookies, brioches, muffins, waffles, brownies, souffles, choux, pies and the like. Examples of the bread include sweet buns, breads with cooked food, loaf bread and the like, and examples of the pastry include danish, croissant and the like. The baking conditions may be those according to common methods of these products.

The fried-in-oil food may include, for example, deep-fried confectionery, deep-fried doughnut, and the like. The steamed food may include, for example, steamed bread, steamed buns with filling (manju), Chinese buns with filling, and the like. The noodle strip food may include, for example, noodles such as udon, ramen and buckwheat noodle (soba), as well as skins such as jiao-zi skins, shao mai skins, and the like. The gelatinous fresh confectionery may include, for example, pudding-like gelatinous fresh confectioneries, jellies, and the like.

It is to be noted that rich taste and leavening can be imparted to baked foods when the full-fat soybean flour-containing composition of the present invention is used. The texture can be improved when used in fried-in-oil foods, whereas addition of voluminousness and suppression of aging are enabled when used in steamed foods. When used in noodle strip foods, improvement of the body, and suppression of sagging are enabled. When used in gelatinous fresh confectioneries, the flavor can be improved.

By using the full-fat soybean flour-containing composition of the present invention, rolled cake not containing any of a wheat flour and milk can be made. Rolled cakes blended with the full-fat soybean flour-containing composition of the present invention in place of the wheat flour and milk have an airy appearance, rich taste and strong sweetness, and also have a moist texture. Therefore, persons who are allergic to the wheat flour or milk can eat roll cakes with relief and can enjoy the taste.

In addition, by using the full-fat soybean flour-containing composition of the present invention, deep-fried confectioneries, steamed breads and the like not containing any of a wheat flour, milk and egg in view of allergy control, as basic ingredients can be also made. In particular, since deep-fried confectioneries in which the full-fat soybean flour-containing composition of the present invention is blended in place of the wheat flour, milk and egg show favorable leavening, and have rich taste and light texture, persons who are allergic to the wheat flour, milk or egg can also eat such confectioneries with relief and can enjoy the taste.

The amount of the full-fat soybean flour-containing composition used in the food may vary depending on the food to be prepared, and for example, in the case of rolled cakes in which the entire of the soft wheat flour is replaced with the full-fat soybean flour-containing composition of the present invention, the composition may be used in an amount of 15 to 20% by mass in the basic ingredients. Also, in the case of deep-fried confectioneries not containing any of a wheat flour, milk and egg as basic ingredients in view of allergy control, the composition may be used in an amount of 50 to 70% by mass in the basic ingredients. Moreover, in the case of loaf breads in which a part of the wheat flour is replaced with the full-fat soybean flour-containing composition of the present invention, the composition may be used in an amount of 2 to 10% by mass in the basic ingredients.

It should be noted that use of the full-fat soybean flour-containing composition in the present invention refers to not only use of the full-fat soybean flour-containing composition itself in producing the food, but also use of each component included in the full-fat soybean flour-containing composition blended separately to consequently produce the food containing all those components.

### Egg Substitute Composition

The egg substitute composition of the present invention is characterized by containing a full-fat soybean flour, a plant protein, an emulsifying agent, and a masking agent. It is to be noted that when the full-fat soybean flour-containing composition explained above is used in applications as an egg substitute, such a composition is referred to as an “egg substitute composition” for clarifying the application.

In the egg substitute composition of the present invention, a full-fat soybean flour is blended for the purpose of elevating the nutritional additional value, and improving the flavor such as rich taste of the food prepared using such an egg substitute composition.

Soybeans, as described above, contain not only high-quality proteins in a large amount, but also functional substances such as soybean lecithin, oligosaccharides, soybean saponins, and isoflavones. Since the egg substitute composition of the present invention contains a full-fat soybean flour obtained by grinding to powderize soybeans as a whole, the entirety of the same is included, and thus has a high nutritional value. In addition, since soybeans do not contain any cholesterol, very preferable egg substitutes can be provided in view of concerns about cholesterol.

As the source material of the full-fat soybean flour in the egg substitute composition of the present invention, commercially available dried soybeans may be used similarly to the aforementioned full-fat soybean flour-containing composition. For example, any one of domestically produced soybeans such as Enrei, Ryuho, Toyohomare and Miyagishirome, and foreign soybeans such as IOM can be used, which may be either genetically modified, or nongenetically modified. Since the soybean is full-fat, it is not obtained from a defatted soybean, generally referred to, as a basic ingredient. Since a soybean flour is used, it is different from “soybean protein” generally referred to. The production method is not particularly limited, and the soybeans as a whole may be ground to permit powderization, or the whole soybean milk may be prepared which may be subsequently subjected to drying and powderization.

In the egg substitute composition of the present invention, the content of the full-fat soybean flour is not particularly limited, and may be adjusted ad libitum in the range enabling the effects of the present invention to be exhibited. However, the composition may be contained usually in an amount of no less than 30% by mass. In the egg substitute composition, it is preferred that the full-fat soybean flour is contained in the largest amount, in light of the nutritional additional value.

In the egg substitute composition of the present invention, a plant protein is blended for the purpose of improving the texture, anti-aging, and maintaining the water holding capacity of the food prepared using the egg substitute composition, and particularly for imparting leavening to baked foods and steamed foods.

The plant protein to be contained in the egg substitute composition of the present invention is not particularly limited as long as it imparts leavening to baked foods and steamed foods. For example, a wheat protein, a soybean protein, a fava bean protein, a garden pea protein, and the like may be exemplified, and these may be used alone, or two or more thereof may be used in combination. Among these, a wheat protein and a soybean protein are preferred in light of the versatility, and these are preferably used either alone, or in combination.

Although the content of the plant protein in the egg substitute composition of the present invention is not particularly limited, the content is preferably 0.1 to 25% by mass, more preferably 1 to 20% by mass, and still more preferably 5 to 20% by mass. When the content falls within such a range, effects of improving the texture, anti-aging, maintaining water holding capacity, as well as imparting leavening to baked foods, and the like can be achieved.

The egg substitute composition of the present invention contains an emulsifying agent. The emulsifying agent contained in the egg substitute composition of the present invention is not particularly limited, and a conventionally well-known emulsifying agent may be used. Examples of the emulsifying agent include various types of organic acid monoglycerides such as soybean lecithin, sucrose fatty acid esters, propylene glycol fatty acid esters, sorbitan fatty acid esters, glycerin fatty acid esters, polyglycerin fatty acid esters, acetic acid monoglycerides, tartaric acid monoglycerides, citric acid monoglycerides and lactic acid monoglycerides, and these may be used alone, or two or more thereof may be used in combination. Alternatively, products generally on the market may be used.

A masking agent is contained in the egg substitute composition of the present invention for the purpose of suppressing a flavor peculiar to the emulsifying agent which can be generated when such an egg substitute composition is used, and gluten odor generated when a wheat protein is used as the plant protein to improve the flavor of the food.

The masking agent to be contained in the egg substitute composition of the present invention is not particularly limited, and a conventionally well-known masking agent may be used. Examples of the masking agent include trehalose, dextrin, highly branched cyclic dextrin, cyclodextrin, sprouted full-fat soybean powders subjected to an enzyme-deactivating treatment and the like, and these may be used alone, or two or more thereof may be used in combination. Among these, it is more preferred that trehalose or highly branched cyclic dextrin having less smell peculiar to the masking agent itself be used. By using trehalose and highly branched cyclic dextrin in combination, the flavor of the food can be further improved. A reference may be made to the aforementioned description with respect to the sprouted full-fat soybean powders.

In the egg substitute composition of the present invention, the content of the emulsifying agent and the content of the masking agent are not particularly limited, but it is preferred that the content of the emulsifying agent in the egg substitute composition be no less than 1% by mass and less than 5% by mass, and the content of the masking agent be greater than 1.5% by mass and no greater than 20% by mass. Herein, the content of the emulsifying agent is more preferably 1 to 4% by mass, and still more preferably 1 to 3% by mass. When the content of the emulsifying agent is no less than 5% by mass, a strong odor of the emulsifying agent may be generated. Moreover, the content of the masking agent is more preferably 3 to 20% by mass, and still more preferably 4 to 15% by mass. When the content of the masking agent is no greater than 1.5% by mass, expected effects may not be exhibited depending on the contents of the emulsifying agent, the plant protein, and the soybean flour in the egg substitute composition.

In the egg substitute composition of the present invention, the total content of the full-fat soybean flour and the plant protein is not particularly limited, and may be adjusted ad libitum in the range enabling the effects of the present invention to be exhibited. The total content is preferably 65 to 97% by mass, more preferably 65 to 90% by mass, still more preferably 65 to 85% by mass, and even more preferably 70 to 85% by mass.

It is preferred that the egg substitute composition of the present invention further contains at least one selected from the group consisting of a plant starch and a rice flour so that a favorable texture can be imparted to the food prepared using such an egg substitute composition. Particularly, in the case of baked foods and steamed foods, favorable leavening can be achieved by containing the plant starch and/or the rice flour.

The plant starch which may be contained in the egg substitute composition of the present invention is not particularly limited, and for example, rice flour starch, wheat starch, maize starch, potato starch, tapioca starch, sweetpotato starch, azuki starch, green bean starch, kudzu starch, Katakuri starch, and the like may be exemplified. Of these, potato starch is preferably used, and in particular, use of raw potato starch and crosslinked potato starch in combination is preferable in light of improvement of the flavor of the food, improvement of the texture, and assists for leavening of the baked foods and steamed foods. The aforementioned plant starch may be used either alone, or as any combination of two or more thereof. When a soybean protein or the like that is believed to have inferior puffing characteristics as compared with wheat proteins is contained, to contain a plant starch and/or a rice flour is particularly preferred for fulfilling the leavening.

The content of the at least one selected from the group consisting of the plant starch and the rice flour in the egg substitute composition of the present invention is not particularly limited, but the upper limit is preferably no greater than 30% by mass, more preferably no greater than 25% by mass, and still more preferably no greater than 20% by mass. The lower limit is preferably no less than 3% by mass, and more preferably no less than 5% by mass. Still more preferably, the content of the plant starch and/or the rice flour is 5 to 20% by mass. When the content falls within this range, flavor and texture of foods can be further improved in light of the balance in blending with the full-fat soybean flour.

Herein, the total amount of the full-fat soybean flour and the plant protein, and the at least one selected from the group consisting of the plant starch and the rice flour in the egg substitute composition of the present invention containing the plant starch and/or the rice flour is not particularly limited, and can be adjusted ad libitum in the range enabling the effects of the present invention to be exhibited. The total content of the full-fat soybean flour and the plant protein, and the at least one selected from the group consisting of the plant starch and the rice flour is preferably 70 to 95% by mass.

In addition, the egg substitute composition of the present invention may further contain food additives such as a corn flour, a nutrient component, a stabilizer, a preservative, a sweetener, a flavor, a colorant and an anti-oxidizing agent to meet the intended object. Furthermore, an excipient, a bulking filler and the like well-known in the art may be contained as needed. For example, for the purpose of changing the texture, a physical property improving agent such as sodium L-ascorbate may be also used.

The egg substitute composition of the present invention refers to a composition for substituting a part or the entirety of egg in an egg-containing food. There is concern about many aspects of use of eggs, such as a short shelf life since they are likely to go rotten, necessity of troublesome operations such as breaking of the eggs and disposal of the egg shells, being a candidate for an allergic factor, containing a large amount of cholesterol and saturated fatty acids, having possibility of contamination with salmonella bacteria, and the like. The egg substitute composition of the present invention solves such problems by substituting a part or the entirety of the egg to be contained in foods. It should be noted that the egg substitute composition of the present invention may be added in production of egg-containing foods for the purpose of still further improving flavor and leavening.

The food of the present invention is characterized in that it is prepared using the aforementioned egg substitute composition. The egg substitute composition of the present invention may be used in any foods which can contain an egg. Accordingly, flavor such as a rich taste is improved. The food may be, for example, a baked food, a fried-in-oil food, steamed food, a gelatinous fresh confectionery, a tamagoyaki, a batter, or the like. The baked food referred to herein means a food prepared by forming and baking a dough including the egg substitute composition described above as a principal component, and may be exemplified by baked confectioneries, breads, pastries, and the like. Examples of the baked confectionery include sponge cakes, pound cakes, tube cakes, pancakes, rolled cakes, castellas, doughnuts, madeleines, biscuits, cookies, brioches, muffins, waffles, brownies, souffles, choux, pies and the like. Examples of the bread include sweet buns, breads with cooked food, loaf bread and the like, and examples of the pastry include danish, croissant and the like. The baking conditions may be those according to common methods of these products.

The fried-in-oil food may include, for example, deep-fried confectionery, deep-fried doughnut, and the like. The steamed food may include, for example, steamed bread, steamed buns with filling (manju), Chinese buns with filling, and the like. The gelatinous fresh confectionery may include, for example, pudding-like gelatinous fresh confectioneries, jellies, and the like.

The egg substitute composition of the present invention may be used in either a food not containing an egg, and in particular, preferably used in a baked food, a steamed food, a gelatinous fresh confectionery, a flour for tempura, or a batter. The egg substitute composition of the present invention can impart rich taste and leavening to baked foods by blending in place of egg. In addition, when used in a pound cake, a moist texture can be imparted to the dough, whereas a crunchy texture can be also imparted when used in cookies.

It is to be noted that the egg substitute composition of the present invention can improve texture when used in fried-in-oil foods, whereas addition of voluminousness and suppression of aging are enabled when used in steamed foods. When used in noodle strip foods, improvement of the body, and suppression of sagging are enabled, whereas the flavor can be improved when used in gelatinous fresh confectioneries. When used in batters, fluffy structure formation and texture can be improved. Therefore, persons who are allergic to the egg can also eat with relief and can enjoy the taste.

Furthermore, the egg substitute composition of the present invention may be also used in steamed bread not containing any of egg, a wheat flour and milk. Steamed breads prepared by blending the egg substitute composition of the present invention in place of egg, wheat flour and milk exhibit favorable leavening, and also have a moist texture. Thus, persons who are allergic to egg, wheat flour or milk can eat with relief and can enjoy the taste.

The amount of the egg substitute composition used in the food may be in the range not to fundamentally alter the favorability originally exhibited by the egg-containing food in which the egg is not substituted, and is preferably an effective amount or a sufficient amount for substituting a part or the entirety of the egg. The amount of the egg substitute composition used cannot be particularly specified when used as a substitute for a part of the egg of an egg-containing food since the amount of the egg used in the egg-containing food varies greatly depending on the food intended. The amount of the egg substitute composition used may be adjusted ad libitum in the range enabling the effects of the present invention to be exhibited. The mode of use may include, for example, a method in which an aqueous solution containing 10 to 50% the egg substitute composition of the present invention is used in place of the entirety or a part of the egg. When the composition is used in an egg-containing food, the flavor and leavening of the egg-containing food can be still further improved. When still further improvement of the flavor and leavening of the egg-containing food is thus intended, the egg substitute composition of the present invention may be further added without decreasing the common amount of the egg used.

It should be noted that use of the egg substitute composition in the present invention refers to not only use of the egg substitute composition itself in producing the food, but also use of each component included in the egg substitute composition blended separately to consequently produce the food containing all those components.

### EXAMPLES

Hereinafter, the present invention is explained in more detail by way of Examples, but the present invention is not any how limited thereto.

### Test Example 1

### Production Example 1

### Production Method of Muffin

Shortening and sugar were kneaded together, and to the mixture were added an egg substitute composition which had been suspended in water before hand, and cow milk. Next, salt, baking powders and soft wheat flour which had been sieved beforehand were added thereto and mixed. Thereafter, the mixture was placed into a pan, and baked in an oven at an upside temperature of 180° C. and a downside temperature of 170° C. for 20 min to produce a muffin. The recipe is shown in Table 1.

TABLE 1

| | Blend |
|---|---|
| Component | (parts by mass) |
| soft wheat flour | 100 |
| baking powder | 1.7 |
| shortening | 50 |
| white superior soft sugar | 50 |
| salt | 0.3 |
| cow milk | 50 |
| egg substitute composition | 12.5 |
| water | 50 |

### Evaluation Method (1)

The leavening and the flavor of the dough were evaluated on the produced muffin. The evaluation was made by ten expert panelists. The evaluation criteria are shown in Table 2. The average score given by the ten panelists of: no less than 2.5 was rated as A; no less than 2 was rated as B; and less than 2 was rated as C.

TABLE 2

| Evaluation | | |
|---|---|---|
| items | Score | Details |
| leavening | 3 | Comparable to the muffin produced using eggs, |
| | | exhibiting protruding leavening at the top. |
| | 2 | Exhibiting significant leavening for baked |
| | | food although somewhat less compared with the |
| | | muffin produced using eggs. |
| | 1 | Not exhibiting leaven, or exhibiting |
| | | insufficient leavening, thereby providing |
| | | heavy texture when eaten. |
| Flavor | 3 | Flavors of emulsifying agent, gluten and |
| | | soybean flour not sensed, thereby permitting |
| | | eating without feeling of strangeness. |
| | 2 | Although flavors of emulsifying agent, gluten |
| | | and soybean flour sensed, eating is permitted |
| | | at an acceptable level. |
| | 1 | Flavors of emulsifying agent, gluten and |
| | | soybean flour sensed, thereby obliging eating |
| | | with feeling of strangeness. |

### Comparative Example 1

A muffin was produced using as an egg substitute composition a mixture of 83 parts by mass of a full-fat soybean flour (Alphaplus HS-600: Nisshin OilliO Group, Ltd.), 10 parts by mass of a wheat protein (A-Glu SS: Glico Foods Co., Ltd.) and 7 parts by mass of reduced starch sugar (Amameal: Hayashibara Shoji, Inc.) as a sweetener. The production method conformed to that in Production Example 1. The results of evaluation are shown in Table 3.

### Comparative Example 2

A muffin was produced using as an egg substitute composition a mixture of 70 parts by mass of a full-fat soybean flour (Alphaplus HS-600: Nisshin OilliO Group, Ltd.), 16 parts by mass of a wheat protein (A-Glu SS: Glico Foods Co., Ltd.) and 14 parts by mass of reduced starch sugar (Amameal: Hayashibara Shoji, Inc.) as a sweetener. The production method conformed to that in Production Example 1. The results of evaluation are shown in Table 3.

### Comparative Example 3

A muffin was produced using as an egg substitute composition a mixture of 65 parts by mass of a full-fat soybean flour (Alphaplus HS-600: Nisshin OilliO Group, Ltd.), 28 parts by mass of a wheat protein (A-Glu SS: Glico Foods Co., Ltd.) and 7 parts by mass of reduced starch sugar (Amameal: Hayashibara Shoji, Inc.) as a sweetener. The production method conformed to that in Production Example 1. The results of evaluation are shown in Table 3.

### Comparative Example 4

A muffin was produced using as an egg substitute composition 100 parts by mass of a full-fat soybean flour (Alphaplus HS-600: Nisshin OilliO Group, Ltd.). The production method conformed to that in Production Example 1. The results of evaluation are shown in Table 3.

TABLE 3

| | full-fat | | | reduced | | | |
|---|---|---|---|---|---|---|---|
| | soybean | plant | emulsifying | starch | masking | evaluation items | |
| parts by mass | flour | protein | agent | syrup | agent | leavening | flavor |
| Comparative | 83 | 10 | — | 7 | — | C | B |
| Example 1 | | | | | | | |
| Comparative | 70 | 16 | — | 14 | — | C | C |
| Example 2 | | | | | | | |
| Comparative | 65 | 28 | — | 7 | — | C | C |
| Example 3 | | | | | | | |
| Comparative | 100 | — | — | — | — | C | B |
| Example 4 | | | | | | | |

plant protein (wheat protein): A-Glu SS (manufactured by Glico Foods Co., Ltd.)
reduced starch syrup: Amameal (Hayashibara Shoji, Inc.)

As is shown in Table 3, the muffin produced using a full-fat soybean flour in place of the egg (Comparative Example 4) exhibited insufficient leavening, in addition had inferior formability, with the dough crumbled. Moreover, the flavor of the soybean was sensed. Also the muffin produced using a full-fat soybean flour in place of the egg, and a wheat protein as a plant protein (Comparative Example 1 to 3) exhibited inferior leavening and formability, with a gluten odor derived from the wheat protein was sensed.

### Test Example 2

### Production Example 2

### Production Method of Pound Cake (1)

Shortening or margarine and sugar were kneaded together, and to the mixture was added an egg substitute composition which had been suspended in water before hand. Next, baking powders and soft wheat flour which had been sieved beforehand were added thereto and mixed. Thereafter, the mixture was placed into a pan, and baked in an oven at an upside temperature of 180° C. and a downside temperature of 170° C. for 45 min to produce a pound cake. The recipe is shown in Table 4.

TABLE 4

| | blend |
|---|---|
| component | (parts by mass} |
| soft wheat flour | 100 |
| baking powder | 2~3 |
| margarine (shortening) | 100 (70) |
| white superior soft sugar | 100 |
| egg substitute composition | 25~30 |
| water | 70~75 |

The leavening and the flavor of the dough were evaluated on the produced pound cake. The evaluation was made according to the Evaluation Method (1).

### Preparation Example 1

### Production Method of Sprouted Full-Fat Soybean Powder

After washing 10 kg of soybean (sold by Nisshin shokai Co., Ltd., trade name “Enrei”) twice with water, 50 kg, i.e., five times the mass of the soybean, of water was added to the mixture to carry out immersion at 30° C. for 3 hrs. Thereafter, while controlling the temperature at 25° C., showering water from above for 10 min once per hour was repeated for 18 hrs to produce the germinated soybean. During the immersion, germination was promoted by bubbling 5000 mL of air per minute. To 10 kg of germinated soybean thus obtained was added 25 kg, i.e., 2.5 times the mass of the germinated soybean, of water, and then was subjected to a mashing treatment twice with a Mass Colloider (manufactured by Masuko Sangyo Co., Ltd.) to obtain a bean homogenate (may be referred to as ‘go’). Here, the slit width of the Mass Colloider in the second treatment was predetermined as half of that in the first treatment. Thus obtained bean homogenate was subjected to an enzyme-deactivating treatment with an UHT pasteurizer at 130° C. for 5 sec to produce an enzyme-deactivated, sprouted whole soybean milk. The sprouted whole soybean milk thus produced was dried by a spray drying process (preset temperature at inlet: 180° C., preset temperature at outlet: 75° C.) to produce enzyme-deactivated, sprouted full-fat soybean powders.

### Example 1

A pound cake was produced using as an egg substitute composition a mixture of 84.1 parts by mass of a full-fat soybean flour (Alphaplus HS-600: Nisshin OilliO Group, Ltd.), 9.0 parts by mass of a wheat protein (A-Glu SS: Glico Foods Co., Ltd.), 2.0 parts by mass of an emulsifying agent (EMULSY KM-500: Riken Vitamin Co., Ltd.), 0.6 parts by mass of an emulsifying agent (POEM B-10: Riken Vitamin Co., Ltd.) and 4.3 parts by mass of the sprouted full-fat soybean powders as a masking agent. The production method conformed to that in Production Example 2. The results of evaluation are shown in Table 5-1 and Table 6 (denoted based on % by mass).

### Example 2

A pound cake was produced using as an egg substitute composition a mixture of 84.1 parts by mass of a full-fat soybean flour (Alphaplus HS-600: Nisshin OilliO Group, Ltd.), 9.0 parts by mass of a wheat protein (A-Glu SS: Glico Foods Co., Ltd.), 2.0 parts by mass of an emulsifying agent (EMULSY KM-500: Riken Vitamin Co., Ltd.), 0.6 parts by mass of an emulsifying agent (SY Glyster GP-120: Sakamoto Yakuhin Kogyo Co., Ltd.) and 4.3 parts by mass of the sprouted full-fat soybean powders as a masking agent. The production method conformed to that in Production Example 2. The results of evaluation are shown in Table 5-1 and Table 6 (denoted based on % by mass).

### Example 3

A pound cake was produced using as an egg substitute composition a mixture of 83.7 parts by mass of a full-fat soybean flour (Alphaplus HS-600: Nisshin OilliO Group, Ltd.), 5.0 parts by mass of a wheat protein (A-Glu SS: Glico Foods Co., Ltd.), 1.5 parts by mass of an emulsifying agent (EMULSY KM-500: Riken Vitamin Co., Ltd.), 0.6 parts by mass of an emulsifying agent (POEM B-10: Riken Vitamin Co., Ltd.) and 9.3 parts by mass of the sprouted full-fat soybean powders as a masking agent. The production method conformed to that in Production Example 2. The results of evaluation are shown in Table 5-1 and Table 6 (denoted based on % by mass).

### Example 4

A pound cake was produced using as an egg substitute composition a mixture of 80.0 parts by mass of a full-fat soybean flour (Alphaplus HS-600: Nisshin OilliO Group, Ltd.), 9.0 parts by mass of a wheat protein (A-Glu SS: Glico Foods Co., Ltd.), 1.5 parts by mass of an emulsifying agent (EMULSY KM-500: Riken Vitamin Co., Ltd.), 0.6 parts by mass of an emulsifying agent (POEM B-10: Riken Vitamin Co., Ltd.) and 8.9 parts by mass of the sprouted full-fat soybean powders as a masking agent. The production method conformed to that in Production Example 2. The results of evaluation are shown in Table 5-1 and Table 6 (denoted based on % by mass).

### Example 5

A pound cake was produced using as an egg substitute composition a mixture of 80.2 parts by mass of a full-fat soybean flour (Alphaplus HS-600: Nisshin OilliO Group, Ltd.), 8.8 parts by mass of a wheat protein (A-Glu SS: Glico Foods Co., Ltd.), 1.4 parts by mass of an emulsifying agent (EMULSY KM-500: Riken Vitamin Co., Ltd.), 0.6 parts by mass of an emulsifying agent (POEM B-10: Riken Vitamin Co., Ltd.) and 9.0 parts by mass of the sprouted full-fat soybean powders as a masking agent. The production method conformed to that in Production Example 2. The results of evaluation are shown in Table 5-1 and Table 6 (denoted based on % by mass).

### Example 6

A pound cake was produced using as an egg substitute composition a mixture of 80.2 parts by mass of a full-fat soybean flour (Alphaplus HS-600: Nisshin OilliO Group, Ltd.), 8.8 parts by mass of a wheat protein (A-Glu SS: Glico Foods Co., Ltd.), 1.4 parts by mass of an emulsifying agent (EMULSY KM-500: Riken Vitamin Co., Ltd.), 0.6 parts by mass of an emulsifying agent (POEM B-10: Riken Vitamin Co., Ltd.) and 9.0 parts by mass of a highly branched cyclic dextrin (Cluster Dextrin: Glico Foods Co., Ltd.) as a masking agent. The production method conformed to that in Production Example 2. The results of evaluation are shown in Table 5-2 and Table 6 (denoted based on % by mass).

### Example 7

A pound cake was produced using as an egg substitute composition a mixture of 80.0 parts by mass of a full-fat soybean flour (Alphaplus HS-600: Nisshin OilliO Group, Ltd.), 10.0 parts by mass of a wheat protein (A-Glu SS: Glico Foods Co., Ltd.), 0.5 parts by mass of an emulsifying agent (POEM B-10: Riken Vitamin Co., Ltd.), 1.2 parts by mass of an emulsifying agent (RYOTO CP-B001: Mitsubishi-Kagaku Foods Corporation) and 8.3 parts by mass of trehalose (TREHA: Hayashibara Shoji, Inc.) as a masking agent. The production method conformed to that in Production Example 2. The results of evaluation are shown in Table 5-2 and Table 6 (denoted based on % by mass).

### Example 8

A pound cake was produced using as an egg substitute composition a mixture of 80.0 parts by mass of a full-fat soybean flour (Alphaplus HS-600: Nisshin OilliO Group, Ltd.), 10.0 parts by mass of a wheat protein (A-Glu SS: Glico Foods Co., Ltd.), 0.5 parts by mass of an emulsifying agent (RYOTO Sugar Ester S-1170: Mitsubishi-Kagaku Foods Corporation), 1.2 parts by mass of an emulsifying agent (RYOTO CP-B001: Mitsubishi-Kagaku Foods Corporation) and 8.3 parts by mass of trehalose (TREHA: Hayashibara Shoji, Inc.) as a masking agent. The production method conformed to that in Production Example 2. The results of evaluation are shown in Table 5-2 and Table 6 (denoted based on % by mass).

### Example 9

A pound cake was produced using as an egg substitute composition a mixture of 84.6 parts by mass of a full-fat soybean flour (Alphaplus HS-600: Nisshin OilliO Group, Ltd.), 10.0 parts by mass of a wheat protein (A-Glu SS: Glico Foods Co., Ltd.), 1.0 parts by mass of an emulsifying agent (EMULSY KM-500: Riken Vitamin Co., Ltd.), 0.3 parts by mass of an emulsifying agent (POEM B-10: Riken Vitamin Co., Ltd.) and 4.3 parts by mass of the sprouted full-fat soybean powders as a masking agent. The production method conformed to that in Production Example 2. The results of evaluation are shown in Table 5-2 and Table 6 (denoted based on % by mass).

### Comparative Example 5

A pound cake was produced using as an egg substitute composition a mixture of 87.9 parts by mass of a full-fat soybean flour (Alphaplus HS-600: Nisshin OilliO Group, Ltd.), 10.6 parts by mass of a wheat protein (A-Glu SS: Glico Foods Co., Ltd.), 1.5 parts by mass of trehalose (TREHA: Hayashibara Shoji, Inc.) as a masking agent, a yeast extract (AROMILD: KOHJIN Co., Ltd.) as a component for imparting rich taste. The production method conformed to that in Production Example 2. The results of evaluation are shown in Table 5-3 and Table 6 (denoted based on % by mass).

### Comparative Example 6

A pound cake was produced using as an egg substitute composition a mixture of 85.7 parts by mass of a full-fat soybean flour (Alphaplus HS-600: Nisshin OilliO Group, Ltd.), 10.0 parts by mass of a wheat protein (A-Glu SS: Glico Foods Co., Ltd.) and 4.3 parts by mass of the sprouted full-fat soybean powders as a masking agent. The production method conformed to that in Production Example 2. The results of evaluation are shown in Table 5-3 and Table 6 (denoted based on % by mass).

### Comparative Example 7

A pound cake was produced using as an egg substitute composition a mixture of 75.0 parts by mass of a full-fat soybean flour (Alphaplus HS-600: Nisshin OilliO Group, Ltd.), 15.0 parts by mass of a wheat protein (A-Glu SS: Glico Foods Co., Ltd.) and 10.0 parts by mass of a highly branched cyclic dextrin (Cluster Dextrin: Glico Foods Co., Ltd.) as a masking agent. The production method conformed to that in Production Example 2. The results of evaluation are shown in Table 5-3 and Table 6 (denoted based on % by mass).

### Comparative Example 8

A pound cake was produced using as an egg substitute composition a mixture of 67.0 parts by mass of a full-fat soybean flour (Alphaplus HS-600: Nisshin OilliO Group, Ltd.), 20.0 parts by mass of a wheat protein (A-Glu SS: Glico Foods Co., Ltd.) and 10.0 parts by mass of a highly branched cyclic dextrin (Cluster Dextrin: Glico Foods Co., Ltd.) as a masking agent. The production method conformed to that in Production Example 2. The results of evaluation are shown in Table 5-3 and Table 6 (denoted based on % by mass).

### Comparative Example 9

A pound cake was produced using as an egg substitute composition a mixture of 80.0 parts by mass of a full-fat soybean flour (Alphaplus HS-600: Nisshin OilliO Group, Ltd.), 10.0 parts by mass of a wheat protein (A-Glu SS: Glico Foods Co., Ltd.) and 10.0 parts by mass of a highly branched cyclic dextrin (Cluster Dextrin: Glico Foods Co., Ltd.) as a masking agent. The production method conformed to that in Production Example 2. The results of evaluation are shown in Table 5 and Table 6 (denoted based on % by mass).

### Comparative Example 10

A pound cake was produced using as an egg substitute composition a mixture of 80.0 parts by mass of a full-fat soybean flour (Alphaplus HS-600: Nisshin OilliO Group, Ltd.), 10.0 parts by mass of a wheat protein (A-Glu SS: Glico Foods Co., Ltd.), 5.0 parts by mass of a highly branched cyclic dextrin (Cluster Dextrin: Glico Foods Co., Ltd.) as a masking agent and 5.0 parts by mass of cellulose (CEOLUS RC-N30: Asahi Kasei Chemicals Corporation) for maintaining formability. The production method conformed to that in Production Example 2. The results of evaluation are shown in Table 5-4 and Table 6 (denoted based on % by mass).

### Comparative Example 11

A pound cake was produced using as an egg substitute composition a mixture of 80.0 parts by mass of a full-fat soybean flour (Alphaplus HS-600: Nisshin OilliO Group, Ltd.), 10.0 parts by mass of a wheat protein (A-Glu SS: Glico Foods Co., Ltd.), 8.8 parts by mass of a highly branched cyclic dextrin (Cluster Dextrin: Glico Foods Co., Ltd.) as a masking agent and 1.2 parts by mass of cellulose (CEOLUS RC-N30: Asahi Kasei Chemicals Corporation) for maintaining formability. The production method conformed to that in Production Example 2. The results of evaluation are shown in Table 5-4 and Table 6 (denoted based on % by mass).

### Comparative Example 12

A pound cake was produced using as an egg substitute composition a mixture of 83.0 parts by mass of a full-fat soybean flour (Alphaplus HS-600: Nisshin OilliO Group, Ltd.), 10.0 parts by mass of a wheat protein (A-Glu SS: Glico Foods Co., Ltd.) and 7.0 parts by mass of a reduced starch syrup (Amameal: Hayashibara Shoji, Inc.) as a sweetener. The production method conformed to that in Production Example 2. The results of evaluation are shown in Table 5-4 and Table 6 (denoted based on % by mass).

### Comparative Example 13

A pound cake was produced using as an egg substitute composition a mixture of 83.0 parts by mass of a full-fat soybean flour (Alphaplus HS-600: Nisshin OilliO Group, Ltd.), 10.0 parts by mass of a wheat protein (A-Glu SS: Glico Foods Co., Ltd.), 5.0 parts by mass of an emulsifying agent (EMULSY KM-500: Riken Vitamin Co., Ltd.) and 7.0 parts by mass of a reduced starch syrup (Amameal: Hayashibara Shoji, Inc.) as a sweetener. The production method conformed to that in Production Example 2. The results of evaluation are shown in Table 5-5 and Table 6 (denoted based on % by mass).

### Comparative Example 14

A pound cake was produced using as an egg substitute composition a mixture of 83.0 parts by mass of a full-fat soybean flour (Alphaplus HS-600: Nisshin OilliO Group, Ltd.), 10.0 parts by mass of a wheat protein (A-Glu SS: Glico Foods Co., Ltd.), 10.0 parts by mass of an emulsifying agent (EMULSY KM-500: Riken Vitamin Co., Ltd.) and 7.0 parts by mass of a reduced starch syrup (Amameal: Hayashibara Shoji, Inc.) as a sweetener. The production method conformed to that in Production Example 2. The results of evaluation are shown in Table 5-5 and Table 6 (denoted based on % by mass).

### Comparative Example 15

A pound cake was produced using as an egg substitute composition a mixture of 83.0 parts by mass of a full-fat soybean flour (Alphaplus HS-600: Nisshin OilliO Group, Ltd.), 10.0 parts by mass of a wheat protein (A-Glu SS: Glico Foods Co., Ltd.), 5.0 parts by mass of an emulsifying agent (EMULSY KM-500: Riken Vitamin Co., Ltd.), 0.5 parts by mass of cellulose (CEOLUS RC-N30: Asahi Kasei Chemicals Corporation) for maintaining formability and 7.0 parts by mass of a reduced starch syrup (Amameal: Hayashibara Shoji, Inc.) as a sweetener. The production method conformed to that in Production Example 2. The results of evaluation are shown in Table 5-5 and Table 6 (denoted based on % by mass).

TABLE 5-1

| parts by mass | | Example 1 | Example 2 | Example 3 | Example 4 | Example 5 |
|---|---|---|---|---|---|---|
| full-fat soybean flour | | 84.1 | 84.1 | 83.7 | 80.0 | 80.2 |
| plant protein | | 9.0 | 9.0 | 5.0 | 9.0 | 8.8 |
| emulsifying agent 1 | | 2.0 | 2.0 | 1.5 | 1.5 | 1.4 |
| emulsifying agent 2 | | 0.6 | — | 0.6 | 0.6 | 0.6 |
| emulsifying agent 3 | | — | 0.6 | — | — | — |
| emulsifying agent 4 | | — | — | — | — | — |
| emulsifying agent 5 | | — | — | — | — | — |
| masking agent 1 | | — | — | — | — | — |
| masking agent 2 | | 4.3 | 4.3 | 9.3 | 8.9 | 9.0 |
| masking agent 3 | | — | — | — | — | — |
| Other Component | | — | — | — | — | — |
| evaluation | leavening | A | A | A | A | A |
| items | flavor | B | B | A | A | A |

plant protein (wheat protein): A-Glu SS (manufactured by Glico Foods Co., Ltd.)
Emulsifying agent 1: EMULSY KM-500 (manufactured by Riken Vitamin Co., Ltd.)
Emulsifying agent 2: POEM B-10 (manufactured by Riken Vitamin Co., Ltd.)
Emulsifying agent 3: SY Glyster GP-120 (manufactured by Sakamoto Yakuhin Kogyo Co., Ltd.)
Emulsifying agent 4: RYOTO Sugar Ester S-1170 (manufactured by Mitsubishi-Kagaku Foods Corporation)
Emulsifying agent 5: RYOTO CP-B001 (manufactured by Mitsubishi-Kagaku Foods Corporation)
Masking agent 1: TREHA (Hayashibara Shoji, Inc.)
Masking agent 2: sprouted full-fat soybean powder
Masking agent 3: Cluster Dextrin (manufactured by Glico Foods Co., Ltd.)

TABLE 5-2

| parts by mass | | Example 6 | Example 7 | Example 8 | Example 9 |
|---|---|---|---|---|---|
| full-fat soybean flour | | 80.2 | 80.0 | 80.0 | 84.6 |
| plant protein | | 8.8 | 10.0 | 10.0 | 10.0 |
| emulsifying agent 1 | | 1.4 | — | — | 1.0 |
| emulsifying agent 2 | | 0.6 | 0.5 | — | 0.3 |
| emulsifying agent 3 | | — | — | — | — |
| emulsifying agent 4 | | — | — | 0.5 | — |
| emulsifying agent 5 | | — | 1.2 | 1.2 | — |
| masking agent 1 | | — | 8.3 | 8.3 | — |
| masking agent 2 | | — | — | — | 4.3 |
| masking agent 3 | | 9.0 | — | — | — |
| Other Component | | — | — | — | — |
| evaluation | leavening | A | B | B | B |
| items | flavor | A | B | B | A |

plant protein (wheat protein): A-Glu SS (manufactured by Glico Foods Co., Ltd.)
Emulsifying agent 1: EMULSY KM-500 (manufactured by Riken Vitamin Co., Ltd.)
Emulsifying agent 2: POEM B-10 (manufactured by Riken Vitamin Co., Ltd.)
Emulsifying agent 3: SY Glyster GP-120 (manufactured by Sakamoto Yakuhin Kogyo Co., Ltd.)
Emulsifying agent 4: RYOTO Sugar Ester S-1170 (manufactured by Mitsubishi-Kagaku Foods Corporation)
Emulsifying agent 5: RYOTO CP-B001 (manufactured by Mitsubishi-Kagaku Foods Corporation)
Masking agent 1: TREHA (Hayashibara Shoji, Inc.)
Masking agent 2: sprouted full-fat soybean powder
Masking agent 3: Cluster Dextrin (manufactured by Glico Foods Co., Ltd.)

TABLE 5-3

| | | Comparative | Comparative | Comparative | Comparative |
|---|---|---|---|---|---|
| parts by mass | | Example 5 | Example 6 | Example 7 | Example 8 |
| full-fat soybean flour | | 87.9 | 85.7 | 75.0 | 67.0 |
| plant protein | | 10.6 | 10.0 | 15.0 | 20.0 |
| emulsifying agent 1 | | — | — | — | — |
| emulsifying agent 2 | | — | — | — | — |
| emulsifying agent 3 | | — | — | — | — |
| emulsifying agent 4 | | — | — | — | — |
| emulsifying agent 5 | | — | — | — | — |
| masking agent 1 | | 1.5 | — | — | — |
| masking agent 2 | | — | 4.3 | — | — |
| masking agent 3 | | — | — | 10.0 | 10.0 |
| Other Component | | 0.02*¹ | — | — | — |
| evaluation | leavening | C | C | B | B |
| items | flavor | C | A | C | C |

plant protein (wheat protein): A-Glu SS (manufactured by Glico Foods Co., Ltd.)
Emulsifying agent 1: EMULSY KM-500 (manufactured by Riken Vitamin Co., Ltd.)
Emulsifying agent 2: POEM B-10 (manufactured by Riken Vitamin Co., Ltd.)
Emulsifying agent 3: SY Glyster GP-120 (manufactured by Sakamoto Yakuhin Kogyo Co., Ltd.)
Emulsifying agent 4: RYOTO Sugar Ester S-1170 (manufactured by Mitsubishi-Kagaku Foods Corporation)
Emulsifying agent 5: RYOTO CP-B001 (manufactured by Mitsubishi-Kagaku Foods Corporation)
Masking agent 1: TREHA (Hayashibara Shoji, Inc.)
Masking agent 2: sprouted full-fat soybean powder
Masking agent 3: Cluster Dextrin (manufactured by Glico Foods Co., Ltd.)
*¹yeast extract (AROMILD: KOHJIN Co., Ltd.)

TABLE 5-4

| | | Comparative | Comparative | Comparative | Comparative |
|---|---|---|---|---|---|
| parts by mass | | Example 9 | Example 10 | Example 11 | Example 12 |
| full-fat soybean flour | | 80.0 | 80.0 | 80.0 | 83.0 |
| plant protein | | 10.0 | 10.0 | 10.0 | 10.0 |
| emulsifying agent 1 | | — | — | — | — |
| emulsifying agent 2 | | — | — | — | — |
| emulsifying agent 3 | | — | — | — | — |
| emulsifying agent 4 | | — | — | — | — |
| emulsifying agent 5 | | — | — | — | — |
| masking agent 1 | | — | — | — | — |
| masking agent 2 | | — | — | — | — |
| masking agent 3 | | 10.0 | 5.0 | 8.8 | — |
| Other Component | | — | 5.0*² | 1.2*² | 7.0*³ |
| evaluation | leavening | C | C | C | C |
| items | flavor | B | B | B | C |

plant protein (wheat protein): A-Glu SS (manufactured by Glico Foods Co., Ltd.)
Emulsifying agent 1: EMULSY KM-500 (manufactured by Riken Vitamin Co., Ltd.)
Emulsifying agent 2: POEM B-10 (manufactured by Riken Vitamin Co., Ltd.)
Emulsifying agent 3: SY Glyster GP-120 (manufactured by Sakamoto Yakuhin Kogyo Co., Ltd.)
Emulsifying agent 4: RYOTO Sugar Ester S-1170 (manufactured by Mitsubishi-Kagaku Foods Corporation)
Emulsifying agent 5: RYOTO CP-B001 (manufactured by Mitsubishi-Kagaku Foods Corporation)
Masking agent 1: TREHA (Hayashibara Shoji, Inc.)
Masking agent 2: sprouted full-fat soybean powder
Masking agent 3: Cluster Dextrin (manufactured by Glico Foods Co., Ltd.)
*²cellulose (CEOLUS RC-N30: manufactured by Asahi Kasei Chemicals Corporation)
*³reduced starch syrup (Amameal: Hayashibara Shoji, Inc.)

TABLE 5-5

| | Comparative | comparative | Comparative | |
|---|---|---|---|---|
| parts by mass | Example 13 | Example 14 | Example 15 | |
| full-fat soybean flour | 83.0 | 83.0 | 83.0 | |
| plant protein | 10.0 | 10.0 | 10.0 | |
| emulsifying agent 1 | 5.0 | 10.0 | 5.0 | |
| emulsifying agent 2 | — | — | — | |
| emulsifying agent 3 | — | — | — | |
| emulsifying agent 4 | — | — | — | |
| emulsifying agent 5 | — | — | — | |
| masking agent 1 | — | — | — | |
| masking agent 2 | — | — | — | |
| masking agent 3 | — | — | — | |
| Other Component | 7.0*³ | 7.0*³ | 0.5*² | 7.0*³ |

| | | | | |
|---|---|---|---|---|
| evaluation | leavening | A | A | A |
| items | flavor | C | C | C |

plant protein (wheat protein): A-Glu SS (manufactured by Glico Foods Co., Ltd.)
Emulsifying agent 1: EMULSY KM-500 (manufactured by Riken Vitamin Co., Ltd.)
Emulsifying agent 2: POEM B-10 (manufactured by Riken Vitamin Co., Ltd.)
Emulsifying agent 3: SY Glyster GP-120 (manufactured by Sakamoto Yakuhin Kogyo Co., Ltd.)
Emulsifying agent 4: RYOTO Sugar Ester S-1170 (manufactured by Mitsubishi-Kagaku Foods Corporation)
Emulsifying agent 5: RYOTO CP-B001 (manufactured by Mitsubishi-Kagaku Foods Corporation)
Masking agent 1: TREHA (Hayashibara Shoji, Inc.)
Masking agent 2: sprouted full-fat soybean powder
Masking agent 3: Cluster Dextrin (manufactured by Glico Foods Co., Ltd.)
*²cellulose (CEOLUS RC-N30: manufactured by Asahi Kasei Chemicals Corporation)
*³reduced starch syrup (Amameal: Hayashibara Shoji, Inc.)

TABLE 6

| | full-fat | | | | | | Total of full-fat |
|---|---|---|---|---|---|---|---|
| | soybean | plant | emulsifying | masking | | | soybean flour, and |
| % by mass | flour | protein | agent | agent | Others | Total | plant protein |
| Example 1 | 84.1 | 9 | 2.6 | 4.3 | — | 100 | 93.1 |
| Example 2 | 84.1 | 9 | 2.6 | 4.3 | — | 100 | 93.1 |
| Example 3 | 83.6 | 5 | 2.1 | 9.3 | — | 100 | 88.6 |
| Example 4 | 80 | 9 | 2.1 | 8.9 | — | 100 | 89 |
| Example 5 | 80.2 | 8.8 | 2 | 9 | — | 100 | 89 |
| Example 6 | 80.2 | 8.8 | 2 | 9 | — | 100 | 89 |
| Example 7 | 80 | 10 | 1.7 | 8.3 | — | 100 | 90 |
| Example 8 | 80 | 10 | 1.7 | 8.3 | — | 100 | 90 |
| Example 9 | 84.4 | 10 | 1.3 | 4.3 | — | 100 | 94.4 |
| Comparative | 87.88 | 10.6 | — | 1.5 | 0.02 | 100 | 98.48 |
| Example 5 | | | | | | | |
| Comparative | 85.7 | 10 | — | 4.3 | — | 100 | 95.7 |
| Example 6 | | | | | | | |
| Comparative | 75 | 15 | — | 10 | — | 100 | 90 |
| Example 7 | | | | | | | |
| Comparative | 69.1 | 20.6 | — | 10.3 | — | 100 | 89.7 |
| Example 8 | | | | | | | |
| Comparative | 80 | 10 | — | 10 | — | 100 | 90 |
| Example 9 | | | | | | | |
| Comparative | 80 | 10 | — | 5 | 5 | 100 | 90 |
| Example 10 | | | | | | | |
| Comparative | 80 | 10 | — | 8.8 | 1.2 | 100 | 90 |
| Example 11 | | | | | | | |
| Comparative | 83 | 10 | — | — | 7 | 100 | 93 |
| Example 12 | | | | | | | |
| Comparative | 79 | 9.5 | 4.8 | — | 6.7 | 100 | 88.5 |
| Example 13 | | | | | | | |
| Comparative | 75.4 | 9.1 | 9.1 | — | 6.4 | 100 | 84.5 |
| Example 14 | | | | | | | |
| Comparative | 78.7 | 9.5 | 4.7 | — | 7.1 | 100 | 88.2 |
| Example 15 | | | | | | | |

As is shown in Table 5-1, Table 5-2, Table 5-3, Table 5-4, Table 5-5 and Table 6, when an emulsifying agent and a masking agent were not contained (Comparative Example 12), the pound cake which was superior in both the leavening and the flavor was not obtained (similar results to those in Comparative Examples 1 to 4). When an emulsifying agent was not contained (Comparative Examples 5 to 11), not only insufficient leavening, but also inferior formability was exhibited. In addition, when the masking agent was not contained (Comparative Examples 13 to 15), unfavorable flavor (smell of the emulsifying agent, and smell of gluten) was generated. The pound cakes prepared using the egg substitute composition of the present invention (Examples 1 to 9) exhibited superior leavening of the dough, and also the pound cake had a favorable flavor. In particular, when the amount of the emulsifying agent and the amount of the masking agent were adjusted to fall within a predetermined range (Examples 4 to 6), any flavor of the emulsifying agent and gluten were not sensed, whereby production of ideal pound cakes was enabled.

### Test Example 3

### Example 10

A pound cake was produced using as an egg substitute composition a mixture of 70.0 parts by mass of a full-fat soybean flour (Alphaplus HS-600: Nisshin OilliO Group, Ltd.), 10.0 parts by mass of a soybean protein (Solpea 4000: Nisshin OilliO Group, Ltd.), 1.0 parts by mass of an emulsifying agent (POEM B-10: Riken Vitamin Co., Ltd.), 2.0 parts by mass of an emulsifying agent (RYOTO CP-B001: Mitsubishi-Kagaku Foods Corporation), 7.0 parts by mass of trehalose (TREHA: Hayashibara Shoji, Inc.) as a masking agent, 10.0 parts by mass of a rice flour (Powder Rice D type: Glico Foods Co., Ltd.) as a plant starch and 0.04 parts by mass of sodium L-ascorbate (sodium L-ascorbate: KANTO CHEMICAL CO., INC.). The production method conformed to that in Production Example 2. The results of evaluation are shown in Table 7 and Table 8 (denoted based on % by mass).

### Example 11

A pound cake was produced using as an egg substitute composition a mixture of 70.0 parts by mass of a full-fat soybean flour (Alphaplus HS-600: Nisshin OilliO Group, Ltd.), 10.0 parts by mass of a soybean protein (Solpea 4000: Nisshin OilliO Group, Ltd.), 1.0 parts by mass of an emulsifying agent (POEM B-10: Riken Vitamin Co., Ltd.), 2.0 parts by mass of an emulsifying agent (RYOTO CP-B001: Mitsubishi-Kagaku Foods Corporation), 7.0 parts by mass of trehalose (TREHA: Hayashibara Shoji, Inc.) as a masking agent and 10.0 parts by mass of a rice flour (Powder Rice D type: Glico Foods Co., Ltd.) as a plant starch. The production method conformed to that in Production Example 2. The results of evaluation are shown in Table 7 and Table 8 (denoted based on % by mass).

### Example 12

A pound cake was produced using as an egg substitute composition a mixture of 65.0 parts by mass of a full-fat soybean flour (Alphaplus HS-600: Nisshin OilliO Group, Ltd.), 10.0 parts by mass of a soybean protein (Solpea 4000: Nisshin OilliO Group, Ltd.), 1.0 parts by mass of an emulsifying agent (POEM B-10: Riken Vitamin Co., Ltd.), 2.0 parts by mass of an emulsifying agent (RYOTO CP-B001: Mitsubishi-Kagaku Foods Corporation), 7.0 parts by mass of trehalose (TREHA: Hayashibara Shoji, Inc.) as a masking agent, 15.0 parts by mass of a rice flour (Powder Rice D type: Glico Foods Co., Ltd.) as a plant starch and 0.04 parts by mass of sodium L-ascorbate (sodium L-ascorbate: KANTO CHEMICAL CO., INC.). The production method conformed to that in Production Example 2. The results of evaluation are shown in Table 7 and Table 8 (denoted based on % by mass).

### Example 13

A pound cake was produced using as an egg substitute composition a mixture of 59.9 parts by mass of a full-fat soybean flour (Alphaplus HS-600: Nisshin OilliO Group, Ltd.), 15.0 parts by mass of a soybean protein (Solpea 4000: Nisshin OilliO Group, Ltd.), 1.0 parts by mass of an emulsifying agent (POEM B-10: Riken Vitamin Co., Ltd.), 2.0 parts by mass of an emulsifying agent (RYOTO CP-B001: Mitsubishi-Kagaku Foods Corporation), 7.0 parts by mass of trehalose (TREHA: Hayashibara Shoji, Inc.) as a masking agent, 15.0 parts by mass of a rice flour (Powder Rice D type: Glico Foods Co., Ltd.) as a plant starch and 0.08 parts by mass of sodium L-ascorbate (sodium L-ascorbate: KANTO CHEMICAL CO., INC.). The production method conformed to that in Production Example 2. The results of evaluation are shown in Table 7 and Table 8 (denoted based on % by mass).

### Example 14

A pound cake was produced using as an egg substitute composition a mixture of 54.9 parts by mass of a full-fat soybean flour (Alphaplus HS-600: Nisshin OilliO Group, Ltd.), 15.0 parts by mass of a soybean protein (Solpea 4000: Nisshin OilliO Group, Ltd.), 1.0 parts by mass of an emulsifying agent (POEM B-10: Riken Vitamin Co., Ltd.), 2.0 parts by mass of an emulsifying agent (RYOTO CP-B001: Mitsubishi-Kagaku Foods Corporation), 7.0 parts by mass of trehalose (TREHA: Hayashibara Shoji, Inc.) as a masking agent, 20.0 parts by mass of a rice flour (Powder Rice D type: Glico Foods Co., Ltd.) as a plant starch and 0.08 parts by mass of sodium L-ascorbate (sodium L-ascorbate: KANTO CHEMICAL CO., INC.). The production method conformed to that in Production Example 2. The results of evaluation are shown in Table 7 and Table 8 (denoted based on % by mass).

### Example 15

A pound cake was produced using as an egg substitute composition a mixture of 49.9 parts by mass of a full-fat soybean flour (Alphaplus HS-600: Nisshin OilliO Group, Ltd.), 20.0 parts by mass of a soybean protein (Solpea 4000: Nisshin OilliO Group, Ltd.), 1.0 parts by mass of an emulsifying agent (POEM B-10: Riken Vitamin Co., Ltd.), 2.0 parts by mass of an emulsifying agent (RYOTO CP-B001: Mitsubishi-Kagaku Foods Corporation), 7.0 parts by mass of trehalose (TREHA: Hayashibara Shoji, Inc.) as a masking agent, 20.0 parts by mass of a rice flour (Powder Rice D type: Glico Foods Co., Ltd.) as a plant starch and 0.08 parts by mass of sodium L-ascorbate (sodium L-ascorbate: KANTO CHEMICAL CO., INC.). The production method conformed to that in Production Example 2. The results of evaluation are shown in Table 7 and Table 8 (denoted based on % by mass).

TABLE 7

| | | Example | Example | Example | Example | Example | Example |
|---|---|---|---|---|---|---|---|
| parts by mass | | 10 | 11 | 12 | 13 | 14 | 15 |
| full-fat soybean flour | | 70.0 | 70.0 | 65.0 | 59.9 | 54.9 | 49.9 |
| plant protein | | 10.0 | 10.0 | 10.0 | 15.0 | 15.0 | 20.0 |
| emulsifying agent 1 | | 1.0 | 1.0 | 1.0 | 1.0 | 1.0 | 1.0 |
| emulsifying agent 2 | | 2.0 | 2.0 | 2.0 | 2.0 | 2.0 | 2.0 |
| masking agent | | 7.0 | 7.0 | 7.0 | 7.0 | 7.0 | 7.0 |
| plant starch | | 10.0 | 10.0 | 15.0 | 15.0 | 20.0 | 20.0 |
| Others *1 | | 0.04 | — | 0.04 | 0.08 | 0.08 | 0.08 |
| evaluation | leavening | B | B | B | B | B | A |
| items | flavor | A | B | B | B | B | A |

Plant protein (soybean protein): Solpea 4000 (manufactured by Nisshin OilliO Group, Ltd.)
emulsifying agent 1: POEM B-10 (manufactured by Riken Vitamin Co., Ltd.)
emulsifying agent 2: RYOTO CP-B001 (manufactured by Mitsubishi-Kagaku Foods Corporation)
masking agent: TREHA (Hayashibara Shoji, Inc.)
plant starch (rice flour): Powder Rice D type (manufactured by Glico Foods Co., Ltd.)
*1: sodium L-ascorbate (KANTO CHEMICAL CO., INC.)

TABLE 8

| | | | | | | | | Total of full-fat |
|---|---|---|---|---|---|---|---|---|
| | full-fat | | | | | | | soybean flour, |
| | soybean | plant | emulsifying | masking | plant | | | plant protein, |
| % by mass | flour | protein | agent | agent | starch | Others | Total | and plant starch |
| Example | 69.96 | 10 | 3 | 7 | 10 | 0.04 | 100 | 89.96 |
| 10 | | | | | | | | |
| Example | 70 | 10 | 3 | 7 | 10 | — | 100 | 90 |
| 11 | | | | | | | | |
| Example | 64.97 | 10 | 3 | 7 | 14.99 | 0.04 | 100 | 89.96 |
| 12 | | | | | | | | |
| Example | 59.92 | 15 | 3 | 7 | 15 | 0.08 | 100 | 89.92 |
| 13 | | | | | | | | |
| Example | 54.92 | 15 | 3 | 7 | 20 | 0.08 | 100 | 89.92 |
| 14 | | | | | | | | |
| Example | 49.92 | 20 | 3 | 7 | 20 | 0.08 | 100 | 89.92 |
| 15 | | | | | | | | |

As is shown in Table 7 and Table 8, in any case in which a rice flour as a plant starch was further blended to the egg substitute composition (Examples 10 to 15), production of cakes having favorable leavening and flavor was enabled. In particular, when the amount of the soybean protein and the amount of the rice flour were adjusted to fall within a predetermined range, production of a cake having very favorable flavor and leavening was enabled (Example 15).

### Test Example 4

### Production Example 3

### Production Method of Pound Cake (2)

Shortening (trade name: Royal short 20, manufactured by Nisshin OilliO Group, Ltd.) and sugar were kneaded together, and to the mixture was added an egg substitute composition which had been suspended in water before hand. Next, baking powders and soft wheat flour which had been sieved beforehand were added thereto and mixed. Thereafter, the mixture was placed into a pan, and baked in an oven at an upside temperature of 180° C. and a downside temperature of 160° C. for 40 min to produce a pound cake. The recipe is shown in Table 9.

TABLE 9

| | blend |
|---|---|
| component | (% by mass) |
| soft wheat flour | 30.12 |
| baking powder | 0.60 |
| shortening | 24.10 |
| white superior | 15.06 |
| soft sugar | |
| egg substitute | 10.03 |
| composition | |
| water | 20.09 |

### Evaluation Method (2)

Sensory evaluation (appearance, and texture) was made on the produced pound cake by nine expert panelists.

### Example 16

A pound cake was produced using as an egg substitute composition a mixture of 70.0 parts by mass of a full-fat soybean flour (Full-fat Soybean Flour X: Nisshin OilliO Group, Ltd.), 10.0 parts by mass of a soybean protein (Solpea 4000: Nisshin OilliO Group, Ltd.), 1.0 parts by mass of an emulsifying agent (POEM B-10: Riken Vitamin Co., Ltd.), 2.0 parts by mass of an emulsifying agent (RYOTO CP-B001: Mitsubishi-Kagaku Foods Corporation), 4.4 parts by mass of trehalose (TREHA: Hayashibara Shoji, Inc.) as a masking agent, 9.0 parts by mass of a highly branched cyclic dextrin (Cluster Dextrin: Glico Foods Co., Ltd.) as a masking agent and 3.6 parts by mass of a tapioca starch (Matsutani Bara: Matsutani Chemical Industry Co., Ltd.; acetylated and crosslinked) as a plant starch. The production method conformed to that in Production Example 3. The blending of the egg substitute composition (denoted based on % by mass) is shown in Table 10. The Full-fat Soybean Flour X was produced by subjecting a dry soybean (basic ingredient) to a shell-removing treatment, and then a heat deodorization treatment, followed by drying, and pulverization (trypsin inhibitor activity: 38.4 TIU/mg).

### Example 17

A pound cake was produced using as an egg substitute composition a mixture of 70.0 parts by mass of a full-fat soybean flour (Full-fat Soybean Flour X: Nisshin OilliO Group, Ltd.), 10.0 parts by mass of a soybean protein (Soya flour FT-N: Nisshin OilliO Group, Ltd.), 1.0 parts by mass of an emulsifying agent (POEM B-10: Riken Vitamin Co., Ltd.), 2.0 parts by mass of an emulsifying agent (RYOTO CP-B001: Mitsubishi-Kagaku Foods Corporation), 9.4 parts by mass of trehalose (TREHA: Hayashibara Shoji, Inc.) as a masking agent and 7.6 parts by mass of a tapioca starch (Matsutani Bara: Matsutani Chemical Industry Co., Ltd.; acetylated and crosslinked) as a plant starch. The production method conformed to that in Production Example 3. The blending of the egg substitute composition (denoted based on % by mass) is shown in Table 10.

### Example 18

A pound cake was produced using as an egg substitute composition a mixture of 70.0 parts by mass of a full-fat soybean flour (Full-fat Soybean Flour X: Nisshin OilliO Group, Ltd.), 5.0 parts by mass of a soybean protein (Soya flour FT-N: Nisshin OilliO Group, Ltd.), 1.0 parts by mass of an emulsifying agent (POEM B-10: Riken Vitamin Co., Ltd.), 2.0 parts by mass of an emulsifying agent (RYOTO CP-5001: Mitsubishi-Kagaku Foods Corporation), 9.4 parts by mass of trehalose (TREHA: Hayashibara Shoji, Inc.) as a masking agent, 5.0 parts by mass of a highly branched cyclic dextrin (Cluster Dextrin: Glico Foods Co., Ltd.) as a masking agent and 7.6 parts by mass of a tapioca starch (Matsutani Bara: Matsutani Chemical Industry Co., Ltd.; acetylated and crosslinked) as a plant starch. The production method conformed to that in Production Example 3. The blending of the egg substitute composition (denoted based on % by mass) is shown in Table 10.

### Example 19

A pound cake was produced using as an egg substitute composition a mixture of 70.0 parts by mass of a full-fat soybean flour (Full-fat Soybean Flour X: Nisshin OilliO Group, Ltd.), 3.0 parts by mass of a soybean protein (Solpea 4000: Nisshin OilliO Group, Ltd.), 5.0 parts by mass of a soybean protein (Soya flour FT-N: Nisshin OilliO Group, Ltd.), 1.0 parts by mass of an emulsifying agent (POEM B-10: Riken Vitamin Co., Ltd.), 2.0 parts by mass of an emulsifying agent (RYOTO CP-3001: Mitsubishi-Kagaku Foods Corporation), 9.4 parts by mass of trehalose (TREHA: Hayashibara Shoji, Inc.) as a masking agent, 2.0 parts by mass of a highly branched cyclic dextrin (Cluster Dextrin: Glico Foods Co., Ltd.) as a masking agent and 7.6 parts by mass of a tapioca starch (Matsutani Bara: Matsutani Chemical Industry Co., Ltd.; acetylated and crosslinked) as a plant starch. The production method conformed to that in Production Example 3. The blending of the egg substitute composition (denoted based on % by mass) is shown in Table 10.

TABLE 10

| | full-fat | plant protein | | | | |
|---|---|---|---|---|---|---|
| | soybean | wheat | soybean | emulsifying | masking | plant |
| % by mass | flour | protein | protein | agent | agent | starch |
| Example | 70.0 | — | 10.0 | 3.0 | 13.4 | 3.6 |
| 16 | | | | | | |
| Example | 70.0 | — | 10.0 | 3.0 | 9.4 | 7.6 |
| 17 | | | | | | |
| Example | 70.0 | — | 5.0 | 3.0 | 14.4 | 7.6 |
| 18 | | | | | | |
| Example | 70.0 | — | 8.0 | 3.0 | 11.4 | 7.6 |
| 19 | | | | | | |

Any of the pound cakes (Examples 16 to 19) exhibited leavening, and had an airy texture. The pound cake produced by blending the egg substitute composition containing defatted soybean powder as a plant protein (Example 17) exhibited better leavening and a bright baked color than the pound cake produced by blending the egg substitute composition containing a powdery soy protein isolates as a plant protein (Example 16). In addition, a soft and airy texture was found. The pound cake produced by blending the egg substitute composition containing a powdery soy protein isolates and defatted soybean powder as a plant protein (Example 19) exhibited the most prominent leavening, was moist and had a soft and airy texture.

### Test Example 5

### Evaluation Method (3)

Sensory evaluation was made on the produced pound cake by nine expert panelists. On the day of the baking, the appearance, the flavor and the texture were evaluated. In addition, on the day after baking, the flavor and the texture were evaluated.

### Example 20

A pound cake was produced using as an egg substitute composition a mixture of 70.0 parts by mass of a full-fat soybean flour (Full-fat Soybean Flour X: Nisshin OilliO Group, Ltd.), 3.0 parts by mass of a soybean protein (Solpea 4000: Nisshin OilliO Group, Ltd.), 5.0 parts by mass of a soybean protein (Soya flour FT-N: Nisshin OilliO Group, Ltd.), 1.0 parts by mass of an emulsifying agent (POEM B-10: Riken Vitamin Co., Ltd.), 2.0 parts by mass of an emulsifying agent (RYOTO CP-B001: Mitsubishi-Kagaku Foods Corporation), 9.4 parts by mass of trehalose (TREHA: Hayashibara Shoji, Inc.) as a masking agent, 2.0 parts by mass of a highly branched cyclic dextrin (Cluster Dextrin: Glico Foods Co., Ltd.) as a masking agent and 7.6 parts by mass of a potato starch (FARINEX AG-600: Matsutani Chemical Industry Co., Ltd.; etherified) as a plant starch. The production method conformed to that in Production Example 3. The blending of the egg substitute composition (denoted based on % by mass) is shown in Table 11-1.

### Example 21

A pound cake was produced using as an egg substitute composition a mixture of 70.0 parts by mass of a full-fat soybean flour (Full-fat Soybean Flour X: Nisshin OilliO Group, Ltd.), 3.0 parts by mass of a soybean protein (Solpea 4000: Nisshin OilliO Group, Ltd.), 5.0 parts by mass of a soybean protein (Soya flour FT-N: Nisshin OilliO Group, Ltd.), 1.0 parts by mass of an emulsifying agent (POEM B-10: Riken Vitamin Co., Ltd.), 2.0 parts by mass of an emulsifying agent (RYOTO CP-B001: Mitsubishi-Kagaku Foods Corporation), 9.4 parts by mass of trehalose (TREHA: Hayashibara Shoji, Inc.) as a masking agent, 2.0 parts by mass of a highly branched cyclic dextrin (Cluster Dextrin: Glico Foods Co., Ltd.) as a masking agent and 7.6 parts by mass of a rice flour (Powder Rice D type: Ezaki Glico Co., Ltd.). The production method conformed to that in Production Example 3. The blending of the egg substitute composition (denoted based on % by mass) is shown in Table 11-1.

### Example 22

A pound cake was produced using as an egg substitute composition a mixture of 70.0 parts by mass of a full-fat soybean flour (Full-fat Soybean Flour X: Nisshin OilliO Group, Ltd.), 3.0 parts by mass of a soybean protein (Solpea 4000: Nisshin OilliO Group, Ltd.), 5.0 parts by mass of a soybean protein (Soya flour FT-N: Nisshin OilliO Group, Ltd.), 1.0 parts by mass of an emulsifying agent (POEM B-10: Riken Vitamin Co., Ltd.), 2.0 parts by mass of an emulsifying agent (RYOTO CP-B001: Mitsubishi-Kagaku Foods Corporation), 9.4 parts by mass of trehalose (TREHA: Hayashibara Shoji, Inc.) as a masking agent, 2.0 parts by mass of a highly branched cyclic dextrin (Cluster Dextrin: Glico Foods Co., Ltd.) as a masking agent and 7.6 parts by mass of a tapioca starch (Matsutani Yuri 2: Matsutani Chemical Industry Co., Ltd.; simple ether-processed product). The production method conformed to that in Production Example 3. The blending of the egg substitute composition (denoted based on % by mass) is shown in Table 11-1.

### Example 23

A pound cake was produced using as an egg substitute composition a mixture of 70.0 parts by mass of a full-fat soybean flour (Full-fat Soybean Flour X: Nisshin OilliO Group, Ltd.), 3.0 parts by mass of a soybean protein (Solpea 4000: Nisshin OilliO Group, Ltd.), 5.0 parts by mass of a soybean protein (Soya flour FT-N: Nisshin OilliO Group, Ltd.), 1.0 parts by mass of an emulsifying agent (POEM B-10: Riken Vitamin Co., Ltd.), 2.0 parts by mass of an emulsifying agent (RYOTO CP-B001: Mitsubishi-Kagaku Foods Corporation), 9.4 parts by mass of trehalose (TREHA: Hayashibara Shoji, Inc.) as a masking agent, 2.0 parts by mass of a highly branched cyclic dextrin (Cluster Dextrin: Glico Foods Co., Ltd.) as a masking agent and 7.6 parts by mass of a potato starch (Nerikomi No. 9R: Matsutani Chemical Industry Co., Ltd.; crosslinked). The production method conformed to that in Production Example 3. The blending of the egg substitute composition (denoted based on % by mass) is shown in Table 11-1.

### Example 24

A pound cake was produced using as an egg substitute composition a mixture of 70.0 parts by mass of a full-fat soybean flour (Full-fat Soybean Flour X: Nisshin OilliO Group, Ltd.), 3.0 parts by mass of a soybean protein (Solpea 4000: Nisshin OilliO Group, Ltd.), 5.0 parts by mass of a soybean protein (Soya flour FT-N: Nisshin OilliO Group, Ltd.), 1.0 parts by mass of an emulsifying agent (POEM B-10: Riken Vitamin Co., Ltd.), 2.0 parts by mass of an emulsifying agent (RYOTO CP-B001: Mitsubishi-Kagaku Foods Corporation), 9.4 parts by mass of trehalose (TREHA: Hayashibara Shoji, Inc.) as a masking agent, 2.0 parts by mass of a highly branched cyclic dextrin (Cluster Dextrin: Glico Foods Co., Ltd.) as a masking agent and 7.6 parts by mass of a potato starch (Matsunorin P-7: Matsutani Chemical Industry Co., Ltd.; ether crosslinked a). The production method conformed to that in Production Example 3. The blending of the egg substitute composition (denoted based on % by mass) is shown in Table 11-2.

### Example 25

A pound cake was produced using as an egg substitute composition a mixture of 70.0 parts by mass of a full-fat soybean flour (Full-fat Soybean Flour X: Nisshin OilliO Group, Ltd.), 3.0 parts by mass of a soybean protein (Solpea 4000: Nisshin OilliO Group, Ltd.), 5.0 parts by mass of a soybean protein (Soya flour FT-N: Nisshin OilliO Group, Ltd.), 1.0 parts by mass of an emulsifying agent (POEM B-10: Riken Vitamin Co., Ltd.), 2.0 parts by mass of an emulsifying agent (RYOTO CP-B001: Mitsubishi-Kagaku Foods Corporation), 9.4 parts by mass of trehalose (TREHA: Hayashibara Shoji, Inc.) as a masking agent, 2.0 parts by mass of a highly branched cyclic dextrin (Cluster Dextrin: Glico Foods Co., Ltd.) as a masking agent and 7.6 parts by mass of a potato starch (raw potato starch: Tokai Denpun Co., Ltd.; raw). The production method conformed to that in Production Example 3. The blending of the egg substitute composition (denoted based on % by mass) is shown in Table 11-2.

### Example 26

A pound cake was produced using as an egg substitute composition a mixture of 70.0 parts by mass of a full-fat soybean flour (Full-fat Soybean Flour X: Nisshin OilliO Group, Ltd.), 3.0 parts by mass of a soybean protein (Solpea 4000: Nisshin OilliO Group, Ltd.), 5.0 parts by mass of a soybean protein (Soya flour FT-N: Nisshin OilliO Group, Ltd.), 1.0 parts by mass of an emulsifying agent (POEM B-10: Riken Vitamin Co., Ltd.), 2.0 parts by mass of an emulsifying agent (RYOTO CP-B001: Mitsubishi-Kagaku Foods Corporation), 9.4 parts by mass of trehalose (TREHA: Hayashibara Shoji, Inc.) as a masking agent, 2.0 parts by mass of a highly branched cyclic dextrin (Cluster Dextrin: Glico Foods Co., Ltd.) as a masking agent, 3.8 parts by mass of a potato starch (Nerikomi No. 9R: Matsutani Chemical Industry Co., Ltd.; crosslinked) and 3.8 parts by mass of a potato starch (raw potato starch: Tokai Denpun Co., Ltd.; raw). The production method conformed to that in Production Example 3. The blending of the egg substitute composition (denoted based on % by mass) is shown in Table 11-2.

### Example 27

A pound cake was produced using as an egg substitute composition a mixture of 70.0 parts by mass of a full-fat soybean flour (Full-fat Soybean Flour X: Nisshin OilliO Group, Ltd.), 3.0 parts by mass of a soybean protein (Solpea 4000: Nisshin OilliO Group, Ltd.), 5.0 parts by mass of a soybean protein (Soya flour FT-N: Nisshin OilliO Group, Ltd.), 1.0 parts by mass of an emulsifying agent (POEM B-10: Riken Vitamin Co., Ltd.), 2.0 parts by mass of an emulsifying agent (RYOTO CP-B001: Mitsubishi-Kagaku Foods Corporation), 9.4 parts by mass of trehalose (TREHA: Hayashibara Shoji, Inc.) as a masking agent, 2.0 parts by mass of a highly branched cyclic dextrin (Cluster Dextrin: Glico Foods Co., Ltd.) as a masking agent, 5.1 parts by mass of a potato starch (Nerikomi No. 9R: Matsutani Chemical Industry Co., Ltd.; crosslinked) and 2.5 parts by mass of a potato starch (raw potato starch: Tokai Denpun Co., Ltd.; raw). The production method conformed to that in Production Example 3. The blending of the egg substitute composition (denoted based on % by mass) is shown in Table 11-2.

TABLE 11-1

| % by mass | Example 19 | Example 20 | Example 21 | Example 22 | Example 23 |
|---|---|---|---|---|---|
| full-fat soybean flour | 70.0 | 70.0 | 70.0 | 70.0 | 70.0 |
| soybean protein | 8.0 | 8.0 | 8.0 | 8.0 | 8.0 |
| emulsifying agent | 3.0 | 3.0 | 3.0 | 3.0 | 3.0 |
| masking agent | 11.4 | 11.4 | 11.4 | 11.4 | 11.4 |
| plant starch 1 | 7.6 | — | — | — | — |
| plant starch 2 | — | 7.6 | — | — | — |
| plant starch 3 | — | — | — | 7.6 | — |
| plant starch 4 | — | — | — | — | 7.6 |
| plant starch 5 | — | — | — | — | — |
| plant starch 6 | — | — | — | — | — |
| rice flour | — | — | 7.6 | — | — |

plant starch 1: tapioca starch (acetylated and crosslinked)
plant starch 2: potato starch (etherified)
plant starch 3: tapioca starch (simple ether-processed product)
plant starch 4: crosslinked potato starch
plant starch 5: potato starch (ether crosslinked α)
plant starch 6: potato starch (raw)

TABLE 11-2

| | Example | Example | Example | Example |
|---|---|---|---|---|
| % by mass | 24 | 25 | 26 | 27 |
| full-fat soybean flour | 70.0 | 70.0 | 70.0 | 70.0 |
| soybean protein | 8.0 | 8.0 | 8.0 | 8.0 |
| emulsifying agent | 3.0 | 3.0 | 3.0 | 3.0 |
| masking agent | 11.4 | 11.4 | 11.4 | 11.4 |
| plant starch 1 | — | — | — | — |
| plant starch 2 | — | — | — | — |
| plant starch 3 | — | — | — | — |
| plant starch 4 | — | — | 3.8 | 5.1 |
| plant starch 5 | 7.6 | — | — | — |
| plant starch 6 | — | 7.6 | 3.8 | 2.5 |
| rice flour | — | — | — | — |

plant starch 1: tapioca starch (acetylated and crosslinked)
plant starch 2: potato starch (etherified)
plant starch 3: tapioca starch (simple ether-processed product)
plant starch 4: crosslinked potato starch
plant starch 5: potato starch (ether crosslinked α)
plant starch 6: potato starch (raw)

### [Evaluation on the Day of Baking]

Any of the pound cakes (Examples 19 to 27) exhibited leavening, and had an airy texture. The pound cakes produced using the egg substitute composition containing a potato starch as a plant starch (Examples 20, 23 and 25), and the pound cake produced using the egg substitute composition containing a rice flour starch (Example 21) exhibited favorable leavening as compared with those containing a tapioca starch as a plant starch (Examples 19 and 22). In particular, the pound cake produced using the egg substitute composition containing a crosslinked potato starch (Example 23) had favorable flavor and texture, and exhibited voluminous leavening although a crater was generated at the central part, showing the best state entirely among Examples 19 to 25. In addition, a crater was not generated at the central part on the pound cake produced using the egg substitute composition containing a raw potato starch (Example 25) although the flavor and the texture were inferior as compared with the pound cake produced using the egg substitute composition containing a crosslinked potato starch (Example 23). The pound cakes produced using the egg substitute composition containing a raw potato starch and a crosslinked potato starch (Examples 26 and 27) exhibited both favorable flavor and texture without generating a crater, showing a better state even in comparison with the pound cake produced using the egg substitute composition containing a crosslinked potato starch (Example 23). A crater was generated at the central part on the pound cake produced using the egg substitute composition containing an ether crosslinked potato starch (Example 24), and the most unfavorable leavening was exhibited.

### [Evaluation on the Day After Baking]

When the evaluation was made on the pound cake which had been allowed to stand at ambient temperature after the baking, the pound cake produced using the egg substitute composition containing a crosslinked potato starch (Example 23) had both favorable flavor and texture, showing the best state entirely among Examples 19 to 25. The pound cake produced using the egg substitute composition containing a raw potato starch and a crosslinked potato starch (Examples 26 and 27) exhibited both favorable flavor and texture also on the day after baking. Particularly, smooth meltability in mouth and moist texture were exhibited in Example 26.

The results of comparative evaluation carried out Example 19 and Example 26 that achieved favorable results in the aforementioned evaluations are shown in Table 12. In Table 12, for example, the results shown in the column of “Example 19” indicate that: two among nine panelists determined that the flavor of Example 19 was better than that of Example 26; one among nine panelists determined that more airy texture was exhibited in Example 19 than that in Example 26; and one among nine panelists determined that less dryness was sensed in Example 19 than that in Example 26. Additionally, the results shown in the column of “Example 19 rather preferred” indicate that: one among nine panelists determined that the flavor of Example 19 was better rather than that of Example 26; two among nine panelists determined that more airy texture was exhibited in Example 19 rather than that in Example 26; and two among nine panelists determined that less dryness was sensed in Example 19 rather than that in Example 26. Moreover, the results shown in the column of “neutral” indicate when Example 19 was compared with Example 26 that: three among nine panelists could not determine which flavor was more favorable; one among nine panelists could not determine which exhibited more airy texture; and one among nine panelists could not determine which gave less dryness.

TABLE 12

| | having good | having airy | having less |
|---|---|---|---|
| | flavor | texture | dryness |
| Example 19 | 2/9 panelists | 1/9 panelists | 1/9 panelists |
| Example 19 rather | 1/9 panelists | 2/9 panelists | 2/9 panelists |
| preferred | | | |
| neutral | 3/9 panelists | 1/9 panelists | 1/9 panelists |
| Example 26 rather | 1/9 panelists | 1/9 panelists | 1/9 panelists |
| preferred | | | |
| Example 26 | 2/9 panelists | 4/9 panelists | 4/9 panelists |

Although no difference was found between Example 19 and Example 26 in terms of the flavor, more favorable results were suggested in Example 26 in terms of the texture.

### Test Example 6

### Production Example 4

### Production Method of Pound Cake (3)

A basic ingredient mix B was mixed using a KENMIX mixer (product name: KENMIX MAJOR, Aicohsha Manufacturing Co., Ltd.), and therewith was mixed a basic ingredient mix C which had been mixed beforehand. Next, a basic ingredient mix A which had been tenderly mixed beforehand was folded into the mixture, which was placed into a pan, and baked in an oven at an upside temperature of 180° C. and a downside temperature of 160° C. for 50 min to produce a pound cake. The recipe is shown in Table 13.

TABLE 13

| | | blend (% by mass) | | |
|---|---|---|---|---|
| | | Comparative | Example | Example |
| component | | Example 16 | 28 | 29 |
| soft wheat flour | A | 30.12 | 30.12 | 30.12 |
| baking powder | | 0.60 | 0.60 | 0.60 |
| shortening | B | 24.10 | 24.10 | 24.10 |
| white superior soft | | 15.06 | 15.06 | 15.06 |
| sugar | | | | |
| whole egg | C | 30.12 | — | — |
| egg substitute | | — | 10.03 | — |
| composition A | | | | |
| egg substitute | | — | — | 10.03 |
| composition B | | | | |
| water | | — | 20.09 | 20.09 |

### Production Example 5

### Production Method of Egg Substitute Composition A

A full-fat soybean flour (Full-fat Soybean Flour X: Nisshin OilliO Group, Ltd.) in an amount of 80.2 parts by mass, 8.8 parts by mass of a wheat protein (A-Glu SS: Glico Foods Co., Ltd.), 0.6 parts by mass of an emulsifying agent (POEM B-10: Riken Vitamin Co., Ltd.), 1.4 parts by mass of an emulsifying agent (EMULSY KM-500: Riken Vitamin Co., Ltd.) and 9.0 parts by mass of a highly branched cyclic dextrin (Cluster Dextrin: Glico Foods Co., Ltd.) as a masking agent were mixed to obtain an egg substitute composition A. The blending of the egg substitute composition A (denoted based on % by mass) is shown in Table 14.

### Production Example 6

### Production Method of Egg Substitute Composition B

A full-fat soybean flour (Full-fat Soybean Flour X: Nisshin OilliO Group, Ltd.) in an amount of 70.0 parts by mass, 3.0 parts by mass of a soybean protein (Solpea 4000: Nisshin OilliO Group, Ltd.), 5.0 parts by mass of a soybean protein (Soya flour FT-N: Nisshin OilliO Group, Ltd.), 1.0 parts by mass of an emulsifying agent (POEM B-10: Riken Vitamin Co., Ltd.), 2.0 parts by mass of an emulsifying agent (RYOTO CP-B001: Mitsubishi-Kagaku Foods Corporation), 9.4 parts by mass of trehalose (TREHA: Hayashibara Shoji, Inc.) as a masking agent, 2.0 parts by mass of a highly branched cyclic dextrin (Cluster Dextrin: Glico Foods Co., Ltd.) as a masking agent, 3.8 parts by mass of a potato starch (Nerikomi No. 9R: Matsutani Chemical Industry Co., Ltd.; crosslinked) as a plant starch and 3.8 parts by mass of a potato starch (raw potato starch: Tokai Denpun Co., Ltd.; raw) were mixed to obtain an egg substitute composition B. The blending of the egg substitute composition B (denoted based on % by mass) is shown Table 14.

TABLE 14

| | egg substitute | egg substitute |
|---|---|---|
| % by mass | composition A | composition B |
| full-fat soybean flour | 80.2 | 70.0 |
| soybean protein | — | 8.0 |
| wheat protein | 8.8 | — |
| emulsifying agent | 2.0 | 3.0 |
| masking agent | 9.0 | 11.4 |
| plant starch | — | 7.6 |

It is to be noted that since the egg substitute composition B is completely the same as the full-fat soybean flour-containing composition B described later, when the full-fat soybean flour-containing composition B is particularly used as an application for an egg substitute, it is referred to as the “egg substitute composition B”.

### Evaluation Method (4)

Sensory evaluation was made on the produced pound cake by 12 expert panelists. On the day of the baking, the appearance, the flavor and the texture were evaluated. In addition, on the day after baking, the flavor and the appearance were evaluated.

### Comparative Example 16

A pound cake was produced using whole eggs. The production method of the pound cake conformed to that in Production Example 4.

### Example 28

A pound cake was produced using the egg substitute composition A produced according to the method of Production Example 5, in place of the whole eggs. The production method of the pound cake conformed to that in Production Example 4.

### Example 29

A pound cake was produced using the egg substitute composition B produced according to the method of Production Example 6, in place of the whole eggs. The production method of the pound cake conformed to that in Production Example 4.

### [Evaluation on the Day of Baking]

Any of the pound cakes (Comparative Example 16, and Examples 28 and 29) exhibited leavening. The pound cake produced using the egg substitute composition A containing a wheat protein (Example 28) had some gluten odor, indicating the flavor not so favorable as compared with the pound cake produced using eggs (Comparative Example 16). However, this pound cake had a moist texture, which was more favorable than the pound cake produced using eggs. The pound cake produced using the egg substitute composition B containing a soybean protein and a plant starch (potato starch) (Example 29) exhibited the leavening comparable to that of the pound cake produced using eggs (Comparative Example 16), and also had a more airy and moist texture than the pound cake produced using eggs, as well as favorable flavor.

### [Evaluation on the Day After Baking]

When the evaluation was made on the pound cake which had been allowed to stand at ambient temperature after the baking, the pound cake produced using the egg substitute composition A containing a wheat protein (Comparative Example 16) got dried, although in contrast, the pound cake produced using egg substitute composition (Examples 28 and 29) was moist. The pound cake produced using the egg substitute composition B containing a soybean protein and a plant starch (potato starch) (Example 29) had a better flavor, and an airy and moist texture compared to the pound cake produced using the egg substitute composition A containing a wheat protein (Example 28).

### Test Example 7

### Production Example 7

### Production Method of Waffle

A basic ingredient mix B was placed into a bread case of a home bakery (trade name: Automatic Home Bakery (for home use) HDB-100 (exclusive for one-loaf use), MK Seiko Co., Ltd.), and thereto was added a basic ingredient mix C which had been well mixed and dissolved beforehand. Then, a basic ingredient mix A was charged, and dry yeast was placed on the top of the basic ingredient mix A so as not to be in contact with the moisture, followed by kneading for 20 min. During kneading, unsalted butter was added. After permitting fermentation for 30 min, the dough was tapped briefly to allow for degassing, and divide into 50 g/piece. The dough was gathered to round such that the part at the external side enters inside, and subjected to formation. The dough was placed into a plastic bag at ambient temperature for 30 min, and tapped briefly to allow for degassing. Thereafter, the dough was gathered to round such that the part at the external side enters inside, and subjected to formation. Pearl sugar was attached therearound, and baked with a waffle maker (trade name: VITANTONIO Belgian Waffler) for 4 min to produce a waffle produced using eggs (Comparative Example 17), and a waffle produced using the egg substitute composition B in place of the eggs (Example 30). The recipe is shown in Table 15.

TABLE 15

| | | blend (% by mass) | | |
|---|---|---|---|---|
| | | Comparative | Example | Example |
| component | | Example 17 | 30 | 31 |
| hard wheat flour | A | 33.22 | 33.22 | 33.22 |
| for exclusive | | | | |
| use in sweet buns | | | | |
| white superior | | 4.98 | 4.98 | 4.98 |
| soft sugar | | | | |
| dietary salt | | 0.33 | 0.33 | 0.33 |
| dry yeast | | 1.33 | 1.33 | 1.33 |
| salt-free butter | | 16.61 | 16.61 | 16.61 |
| honey | B | 1.66 | 1.66 | 1.66 |
| water | | 16.61 | 16.61 | 16.61 |
| egg yolk | C | 11.96 | — | — |
| egg substitute | | — | 2.99 | — |
| composition B | | | | |
| egg substitute | | — | — | 2.99 |
| composition C | | | | |
| water | | — | 8.97 | 8.97 |
| pearl sugar | | 13.29 | 13.29 | 13.29 |

### Production Example 8

### Production Method of Egg Substitute Composition C

A full-fat soybean flour (Full-fat Soybean Flour X: Nisshin OilliO Group, Ltd.) in an amount of 70.0 parts by mass, 3.0 parts by mass of a soybean protein (Solpea 4000: Nisshin OilliO Group, Ltd.), 5.0 parts by mass of a soybean protein (Soya flour FT-N: Nisshin OilliO Group, Ltd.), 1.0 parts by mass of an emulsifying agent (POEM B-10: Riken Vitamin Co., Ltd.), 2.0 parts by mass of an emulsifying agent (RYOTO CP-0001: Mitsubishi-Kagaku Foods Corporation), 9.4 parts by mass of trehalose (TREHA: Hayashibara Shoji, Inc.) as a masking agent, 2.0 parts by mass of a highly branched cyclic dextrin (Cluster Dextrin: Glico Foods Co., Ltd.) as a masking agent and 7.6 parts by mass of a tapioca starch (Matsutani Bara: Matsutani Chemical Industry Co., Ltd.; acetylated and crosslinked) as a plant starch were mixed to obtain an egg substitute composition C. The recipe (denoted based on % by mass) is shown in Table 16.

TABLE 16

| | egg substitute |
|---|---|
| % by mass | composition C |
| full-fat soybean flour | 70.0 |
| soybean protein | 8.0 |
| wheat protein | — |
| emulsifying agent | 3.0 |
| masking agent | 11.4 |
| plant starch | 7.6 |

It is to be noted that since the egg substitute composition C is completely the same as the full-fat soybean flour-containing composition C described later, when the full-fat soybean flour-containing composition C is particularly used as an application for an egg substitute, it is referred to as the “egg substitute composition C”.

### Evaluation Method (5)

Sensory evaluation was made on the produced waffle by nine expert panelists. On the day and the day after baking, the flavor and the texture were evaluated.

### Comparative Example 17

A waffle was produced using eggs. The production method of the waffle conformed to that in Production Example 7.

### Example 30

A waffle was produced using the egg substitute composition B produced according to the method of Production Example 6, in place of the eggs. The production method of the waffle conformed to that in Production Example 7.

### Example 31

A waffle was produced using the egg substitute composition C produced according to the method of Production Example 8, in place of the eggs. The production method of the waffle conformed to that in Production Example 7.

### [Evaluation on the Day of Baking]

The waffle produced using the egg substitute composition B in place of the eggs (Example 30), and the waffle produced using the egg substitute composition C in place of the eggs (Example 31) had rich taste and favorable flavor even though eggs were not used. In addition, Example 30 had further airy and chewy/sticky texture as compared with Example 31.

Moreover, the waffle produced using eggs (Comparative Example 17) was compared with the waffle produced using the egg substitute composition B in place of the eggs (Example 30) with respect to the flavor and the texture on the day of the baking. Each item was evaluated on a scale of one to five, and the average of the values was determined. The results of evaluation are shown in Table 17.

TABLE 17

| | | | having | having | |
|---|---|---|---|---|---|
| | having | having | crunchiness | highly | having |
| | airy | moist | on the | crisp | good |
| | texture | texture | surface | texture | flavor |
| Comparative | average | average | average | average | average |
| Example 17 | 3.9 | 3.2 | 3.1 | 4.0 | 3.9 |
| Example 30 | average | average | average | average | average |
| | 4.1 | 3.8 | 3.4 | 3.7 | 4.2 |

### [Evaluation on the Day After Baking]

When the evaluation was made on the waffle which had been allowed to stand at ambient temperature after the baking, the waffle produced using the egg substitute composition B in place of the eggs (Example 30) and the waffle produced using the egg substitute composition C in place of the eggs (Example 31) had airy and chewy/sticky textured, and also favorable flavor. To the contrary, the waffle produced using eggs (Comparative Example 17) generated an odor of deteriorated eggs, and had a dry texture.

In addition, the waffle produced using eggs (Comparative Example 17) was compared with the waffle produced using the egg substitute composition B in place of the eggs (Example 30) with respect to the flavor and texture on the day after baking. The results of evaluation are shown in Table 18.

TABLE 18

| | | | | having | |
|---|---|---|---|---|---|
| | | having | having | highly | having |
| | having airy | moist | chewy/sticky | crisp | good |
| | texture | texture | texture | texture | flavor |
| Comparative | average | average | average | average | average |
| Example 17 | 2.8 | 2.4 | 2.8 | 3.8 | 3.0 |
| Example 30 | average | average | average | average | average |
| | 3.5 | 3.4 | 2.9 | 4.0 | 4.1 |

The waffle produced using the egg substitute composition B (Example 30) was given higher scores in all items of the evaluation than the waffle produced using eggs (Comparative Example 17).

### Test Example 8

### Production Example 9

### Production Method of Tempura

A batter was prepared by tenderly mixing a basic ingredient mix A and wheat flour such that some lumps were left. A shrimp (frozen, with tail) was floured with soft wheat flour, and dipped in the aforementioned batter, and deep-fried using Nissin Vegefruits Oil (Nisshin OilliO Group, Ltd.) at 180° C. for 2 min to produce a tempura produced using eggs (Comparative Example 18), and a tempura produced using the egg substitute composition in place of the eggs (Examples 32 and 33). The recipe is shown in Table 19.

TABLE 19

| | | blend (% by mass) | | |
|---|---|---|---|---|
| | | Comparative | | |
| component | | Example 18 | Example 32 | Example 33 |
| soft wheat flour | | 30.8 | 30.8 | 30.8 |
| egg substitute | A | — | 5.1 | — |
| composition B | | | | |
| egg substitute | | — | — | 5.1 |
| composition C | | | | |
| water | | — | 10.2 | 10.2 |
| whole egg | | 15.4 | — | — |

| | | | |
|---|---|---|---|
| cold water | 53.8 | 53.9 | 53.9 |

### Evaluation Method (6)

Sensory evaluation was made on the produced tempura by 15 expert panelists. The appearance (fluffy structure) of the fried batter (koromo), the flavor, and the texture (crunchiness) were evaluated.

### Comparative Example 18

A tempura was produced using whole eggs. The production method of the tempura conformed to that in Production Example 9.

### Example 32

A tempura was produced using the egg substitute composition B produced according to the method of Production Example 6, in place of the eggs. The production method of the tempura conformed to that in Production Example 9.

### Example 33

A tempura was produced using the egg substitute composition C produced according to the method of Production Example 8, in place of the eggs. The production method of the tempura conformed to that in Production Example 9.

The tempura produced using eggs (Comparative Example 18) exhibited inferior fluffy structure formation, was less voluminous, and had unsatisfactory crunchiness. To the contrary, any of the tempura produced using the egg substitute composition in place of the eggs exhibited superior fluffy structure formation, was voluminous, and also had satisfactory crunchiness (Examples 32 and 33). The tempura produced using the egg substitute composition B containing a potato starch as a plant starch (Example 32) was less oily than the tempura produced using the egg substitute composition C containing a tapioca starch (Example 33), and the koromo was well-made.

The tempura produced using eggs (Comparative Example 18) was compared with the tempura produced using the egg substitute composition B containing a potato starch as a plant starch (Example 32). The results are shown in Table 20.

TABLE 20

| | | | Comprehensive |
|---|---|---|---|
| | appearance | texture | evaluation |
| | (fluffy structure | (crunchiness | (favorability as |
| | formation of tempura) | of tempura) | tempura) |
| Comparative | 0/15 panelists | 0/15 panelists | 0/15 panelists |
| Example 18 | | | |
| Comparative | 0/15 panelists | 0/15 panelists | 1/15 panelists |
| Example 18 | | | |
| rather | | | |
| preferred | | | |
| neutral | 0/15 panelists | 0/15 panelists | 1/15 panelists |
| Example 32 | 7/15 panelists | 6/15 panelists | 4/15 panelists |
| rather | | | |
| preferred | | | |
| Example 32 | 8/15 panelists | 9/15 panelists | 9/15 panelists |

By using the egg substitute composition in place of the eggs, the fluffy structure formation and the crunchiness were improved, and thus it was proven that formation of a koromo preferable for a tempura was enabled.

### Test Example 9

### Production Example 10

### Production Method of Pudding-Like Gelatinous Fresh Confectionery

Cow milk and sugar were placed into a pan which was put on heater to warm to 40° C. A basic ingredient mix A was mixed with a flavor, and thereto was added warmed cow milk (including sugar), and the mixture was blended with a homomixer (10,000 rpm/10 min). The mixture was transferred to the pan, and warmed to 80° C. The pan was put off from the heater, and a basic ingredient mix B was added thereto and dissolved. The mixture was poured into a pudding pan, and cooled to permit hardening. The recipe is shown in Table 21.

TABLE 21

| | | blend (% by mass) | | |
|---|---|---|---|---|
| | | Comparative | | |
| component | | Example 19 | Example 34 | Example 35 |
| cow milk | | 58.46 | 58.46 | 58.46 |
| white superior soft | | 5.07 | 5.07 | 5.07 |
| sugar | | | | |
| full-fat | A | 9.35 | — | — |
| soybean flour | | | | |
| egg substitute | | — | 9.35 | — |
| composition B | | | | |
| egg substitute | | — | — | 9.35 |
| composition C | | | | |
| water | | 18.71 | 18.71 | 18.71 |
| flavor 1 | | 0.08 | 0.08 | 0.08 |
| flavor 2 | | 0.16 | 0.16 | 0.16 |
| gelatin | B | 1.17 | 1.17 | 1.17 |
| hot water | | 7.01 | 7.01 | 7.01 |

flavor 1: vanilla essence
flavor 2: egg custard flavor

### Evaluation Method (7)

Sensory evaluation (flavor and texture) was made on the produced pudding-like gelatinous fresh confectionery by three expert panelists.

### Comparative Example 19

A pudding-like gelatinous fresh confectionery was produced using the full-fat soybean flour (Full-fat Soybean Flour X) in place of the eggs. The production method of the pudding-like gelatinous fresh confectionery conformed to that in Production Example 10.

### Example 34

A pudding-like gelatinous fresh confectionery was produced using the egg substitute composition B produced according to the method of Production Example 6, in place of the eggs. The production method of the pudding-like gelatinous fresh confectionery conformed to that in Production Example 10.

### Example 35

A pudding-like gelatinous fresh confectionery was produced using the egg substitute composition C produced according to the method of Production Example 8, in place of the eggs. The production method of the pudding-like gelatinous fresh confectionery conformed to that in Production Example 10.

Any of the pudding-like gelatinous fresh confectioneries (Comparative Example 19, Examples 34 and 35) had a favorable flavor. However, the pudding-like gelatinous fresh confectionery produced using the full-fat soybean flour (Comparative Example 19) had a powdery texture. The pudding-like gelatinous fresh confectionery produced using the egg substitute composition C containing a potato starch as a plant starch (Example 34) had smoother meltability in mouth and creamy texture than the pudding-like gelatinous fresh confectionery produced using the egg substitute composition A containing a tapioca starch (Example 35).

### Test Example 10

### Production Example 11

### Production Method of Steamed Bread

The powders were mixed and sieved, followed by blending using a KENMIX mixer with the setting of scale 1 for 2 min while adding thereto water in small portions. Next, the mixture was poured into a pan, and steamed over high heat for 15 min. The recipe is shown in Table 22.

TABLE 22

| | blend (% by mass) | | | |
|---|---|---|---|---|
| | Comparative | Comparative | Comparative | |
| component | Example 20 | Example 21 | Example 22 | Example 36 |
| soft wheat flour | 43.42 | — | — | — |
| full-fat soybean | — | 34.74 | 40.43 | — |
| flour | | | | |
| egg substitute | — | — | — | 40.43 |
| composition C | | | | |
| potato starch | — | — | 10.11 | 10.11 |
| baking powder | 0.78 | 0.78 | 1.14 | 1.14 |
| white superior | 10.42 | 10.42 | 15.16 | 15.16 |
| soft sugar | | | | |
| dietary salt | 0.22 | 0.22 | 0.32 | 0.32 |
| water | — | 8.68 | 32.85 | 32.85 |
| whole egg | 10.42 | 10.42 | — | — |
| cow milk | 20.84 | 20.84 | — | — |
| salt-free butter | 13.89 | 13.89 | — | — |

### Evaluation Method (8)

Sensory evaluation was made on the produced steamed bread by nine expert panelists. On the day and the day after baking, the flavor and the texture were evaluated.

### Comparative Example 20

A steamed bread was produced using wheat, eggs, and milk. The production method of the steamed bread conformed to that in Production Example 11.

### Comparative Example 21

A steamed bread was produced using eggs and milk, and the full-fat soybean flour (Full-fat Soybean Flour X) in place of the wheat. The production method of the steamed bread conformed to that in Production Example 11.

### Comparative Example 22

A steamed bread was produced without using wheat, egg, and milk, but using the full-fat soybean flour (Full-fat Soybean Flour X) in place of the wheat. The production method of the steamed bread conformed to that in Production Example 11.

### Example 36

A steamed bread was produced without using wheat, egg, and milk, but using the egg substitute composition C produced according to the method of Production Example 8 in place of the wheat. The production method of the steamed bread conformed to that in Production Example 11.

### [Evaluation on the Day of Baking]

Any of the steamed breads (Comparative Examples 20, 21 and 22, and Example 36) exhibited favorable leavening. However, the steamed bread produced using the wheat, egg, and milk (Comparative Example 20) immediately got dried and hardened. In addition, the steamed bread using the eggs and milk, and using the full-fat soybean flour in place of the wheat (Comparative Example 21) had smooth meltability in mouth, and a strong soybean flavor. The steamed bread produced without using the wheat, eggs and milk, and using the full-fat soybean flour in place of the wheat (Comparative Example 22) had an airy texture, but still had a strong soybean flavor. To the contrary, the steamed bread produced without using the wheat, eggs and milk, and using the egg substitute composition C in place of the wheat (Example 36) had an airy and moist texture, as well as a good taste, and further, such a state was maintained even after several hours passed.

### [Evaluation on the Day After Baking]

The steamed bread produced using the wheat, eggs, and milk (Comparative Example 20) got dried and was hardened, and had a bad flavor. The steamed bread using the eggs and milk, and using the full-fat soybean flour in place of the wheat (Comparative Example 21) was moister than the day before, but had an unfavorable flavor. The steamed bread produced without using the wheat, eggs and milk, and using the full-fat soybean flour in place of the wheat (Comparative Example 22) was unchanged from the day before, having the airy texture, but having an unfavorable flavor. To the contrary, the steamed bread produced without using the wheat, eggs and milk, and using the egg substitute composition C in place of the wheat (Example 36) had an airy and moist texture, as well as a good taste similarly to the day before, and also had a favorable flavor.

### Test Example 11

### Production Example 12

### Production Method of Steamed Bread

The powders were mixed and sieved, followed by blending using a KENMIX mixer with the setting of scale 1 for 2 min while adding thereto water in portions. Next, the mixture was poured into a pan, and steamed over high heat for 15 min. The recipe is shown in Table 23.

TABLE 23

| | blend (% by mass) | | |
|---|---|---|---|
| | Comparative | | |
| component | Example 23 | Example 37 | Example 38 |
| soft wheat flour | 40.43 | — | — |
| full-fat soybean | — | — | 40.43 |
| flour-containing | | | |
| composition B | | | |
| full-fat soybean | — | 40.43 | — |
| flour-containing | | | |
| composition C | | | |
| potato starch | 10.11 | 10.11 | 10.11 |
| baking powder | 1.14 | 1.14 | 1.14 |
| white superior soft | 15.16 | 15.16 | 15.16 |
| sugar | | | |
| dietary salt | 0.32 | 0.32 | 0.32 |
| water | 32.85 | 32.85 | 32.85 |

### Production Example 13

### Production Method of Full-Fat Soybean Flour-Containing Composition B

A full-fat soybean flour (Full-fat Soybean Flour X: Nisshin OilliO Group, Ltd.) in an amount of 70.0 parts by mass, 3.0 parts by mass of a soybean protein (Solpea 4000: Nisshin OilliO Group, Ltd.), 5.0 parts by mass of a soybean protein (Soya flour FT-N: Nisshin OilliO Group, Ltd.), 1.0 parts by mass of an emulsifying agent (POEM B-10: Riken Vitamin Co., Ltd.), 2.0 parts by mass of an emulsifying agent (RYOTO CP-B001: Mitsubishi-Kagaku Foods Corporation), 9.4 parts by mass of trehalose (TREHA: Hayashibara Shoji, Inc.) as a masking agent, 2.0 parts by mass of a highly branched cyclic dextrin (Cluster Dextrin: Glico Foods Co., Ltd.) as a masking agent, 3.8 parts by mass of a potato starch (Nerikomi No. 9R: Matsutani Chemical Industry Co., Ltd.; crosslinked) as a plant starch and 3.8 parts by mass of a potato starch (raw potato starch: Tokai Denpun Co., Ltd.; raw) were mixed to obtain a full-fat soybean flour-containing composition B. The recipe (denoted based on % by mass) is shown in Table 24.

### Production Example 14

### Production Method of Full-Fat Soybean Flour-Containing Composition C

A full-fat soybean flour (Full-fat Soybean Flour X: Nisshin OilliO Group, Ltd.) in an amount of 70.0 parts by mass, 3.0 parts by mass of a soybean protein (Solpea 4000: Nisshin OilliO Group, Ltd.), 5.0 parts by mass of a soybean protein (Soya flour FT-N: Nisshin OilliO Group, Ltd.), 1.0 parts by mass of an emulsifying agent (POEM B-10: Riken Vitamin Co., Ltd.), 2.0 parts by mass of an emulsifying agent (RYOTO CP-B001: Mitsubishi-Kagaku Foods Corporation), 9.4 parts by mass of trehalose (TREHA: Hayashibara Shoji, Inc.) as a masking agent, 2.0 parts by mass of a highly branched cyclic dextrin (Cluster Dextrin: Glico Foods Co., Ltd.) as a masking agent and 7.6 parts by mass of a tapioca starch (Matsutani Bara: Matsutani Chemical Industry Co., Ltd.; acetylated and crosslinked) as a plant starch were mixed to obtain a full-fat soybean flour-containing composition C. The recipe (denoted based on % by mass) is shown in Table 24.

TABLE 24

| | full-fat soybean | full-fat soybean |
|---|---|---|
| | flour-containing | flour-containing |
| % by mass | composition B | composition C |
| full-fat soybean flour | 70.0 | 70.0 |
| soybean protein | 8.0 | 8.0 |
| emulsifying agent | 3.0 | 3.0 |
| masking agent | 11.4 | 11.4 |
| plant starch 1 | 3.8 | — |
| plant starch 2 | 3.8 | — |
| plant starch 3 | — | 7.6 |

plant starch 1: potato starch (Nerikomi No, 9R: Matsutani Chemical Industry Co., Ltd.; crosslinked)
plant starch 2: potato starch (raw potato starch: Tokai Denpun Co., Ltd., raw)
plant starch 3: tapioca starch (Matsutani Bara: Matsutani Chemical Industry Co., Ltd.; acetylated and crosslinked)

### Evaluation Method (9)

Sensory evaluation was made on the produced steamed bread by nine expert panelists. On the day and the day after baking, the flavor and the texture were evaluated. Further, with respect to the flavor and texture, each item was evaluated on a scale of one to five, and the average of the values was determined.

### Comparative Example 23

A steamed bread was produced using a wheat flour. The production method of the steamed bread conformed to that in Production Example 12.

### Example 37

A steamed bread was produced using the full-fat soybean flour-containing composition C produced according to the method of Production Example 14. The production method of the steamed bread conformed to that in Production Example 12.

### Example 38

A steamed bread was produced using the full-fat soybean flour-containing composition B produced according to the method of Production Example 13. The production method of the steamed bread conformed to that in Production Example 12.

### [Evaluation on the Day of Baking]

Any of the steamed breads (Comparative Example 23, and Examples 37 and 38) exhibited favorable leavening. However, the steamed bread produced using the wheat flour (Comparative Example 23) had a strong chewy/sticky texture, and had a smell derived from the flour. The steamed bread produced using the full-fat soybean flour-containing composition B containing a potato starch as a plant starch (Example 38) was moister and more airy than the steamed bread produced using the full-fat soybean flour-containing composition C containing a tapioca starch (Example 37). The steamed bread produced using the full-fat soybean flour-containing composition had a rich taste and strong sweetness, and a pronounced flavor,

The results of the evaluation compared between the steamed bread produced using the wheat flour (Comparative Example 23), and the steamed bread produced using the full-fat soybean flour-containing composition B containing a potato starch in place of the wheat (Example 38) on the day of the baking are shown in Table 25.

TABLE 25

| | | having | having | having |
|---|---|---|---|---|
| | having airy | moist | chewy/sticky | good |
| | texture | texture | texture | flavor |
| Comparative | average | average | average | average |
| Example 23 | 2.0 | 3.2 | 3.2 | 3.0 |
| Example 38 | average | average | average | average |
| | 3.3 | 3.7 | 1.8 | 3.2 |

### [Evaluation on the Day After Baking]

The steamed bread produced using the wheat flour (Comparative Example 23) aged, and was in a hard and powdery state. The steamed bread produced using the full-fat soybean flour-containing composition did not age, and kept the moist texture. The steamed bread produced using the full-fat soybean flour-containing composition B containing a potato starch as a plant starch (Example 38) kept the more moist texture and airy texture, and had a more favorable flavor than the steamed bread produced using the full-fat soybean flour-containing composition C containing a tapioca starch (Example 37).

The results of the evaluation compared between the steamed bread produced using the wheat flour (Comparative Example 23), and the steamed bread produced using the full-fat soybean flour-containing composition B containing a potato starch in place of the wheat (Example 38) on the day after baking are shown in Table 26.

TABLE 26

| | | having | having | having | having |
|---|---|---|---|---|---|
| | having airy | moist | chewy/sticky | powdery | good |
| | texture | texture | texture | texture | flavor |
| Comparative | average | average | average | average | average |
| Example 23 | 1.5 | 2.3 | 2.7 | 3.9 | 2.6 |
| Example 38 | average | average | average | average | average |
| | 3.4 | 4.0 | 1.8 | 3.4 | 2.6 |

### Test Example 12

### Production Example 15

### Production Method of Loaf Bread

Powders other than yeast were mixed. Water was placed into a bread case of a home bakery (trade name: Automatic Home Bakery (for home use) HDB-100 (exclusive for one-loaf use), MK Seiko Co., Ltd.), and the mixed powders were placed thereon. The yeast was placed on the powders so as not to be in contact with water. The operation was started with a loaf bread mode, and a shortening was added after kneading for 3 min, whereby a loaf bread was produced. The recipe is shown in Table 27.

TABLE 27

| | blend (% by mass) | | | |
|---|---|---|---|---|
| | Comparative | Comparative | Exam- | |
| component | Example 24 | Example 25 | ple 39 | Example 40 |
| hard wheat flour | 55.1 | 52.3 | 52.3 | 52.3 |
| full-fat soybean | — | 2.8 | — | — |
| flour | | | | |
| full-fat soybean | — | — | 2.8 | — |
| flour-containing | | | | |
| composition B | | | | |
| full-fat soybean | — | — | — | 2.8 |
| flour-containing | | | | |
| composition C | | | | |
| white superior soft | 3.3 | 3.3 | 3.3 | 3.3 |
| sugar | | | | |
| dry yeast | 0.4 | 0.4 | 0.4 | 0.4 |
| water | 38.5 | 38.5 | 38.5 | 38.5 |
| dietary salt | 1.0 | 1.0 | 1.0 | 1.0 |
| shortening | 1.7 | 1.7 | 1.7 | 1.7 |

### Evaluation Method (10)

Sensory evaluation was made on the produced loaf bread by ten expert panelists. On the day of the baking, the appearance, the flavor and the texture were evaluated. In addition, on the day after baking, the flavor and the texture were evaluated on the bread which had been allowed to stand at ambient temperature in a plastic bag.

### Comparative Example 24

A loaf bread was produced using a hard wheat flour. The production method of the loaf bread conformed to that in Production Example 15.

### Comparative Example 25

A loaf bread was produced using the hard full-fat soybean flour (Full-fat Soybean Flour X) in place of 5% of the hard wheat flour. The production method of the loaf bread conformed to that in Production Example 15.

### Example 39

A loaf bread was produced using the full-fat soybean flour-containing composition B produced according to the method of Production Example 13 in place of 5% of the hard wheat flour. The production method of the loaf bread conformed to that in Production Example 15.

### Example 40

A loaf bread was produced using the full-fat soybean flour-containing composition C produced according to the method of Production Example 14 in place of 5% of the hard wheat flour. The production method of the loaf bread conformed to that in Production Example 15.

### [Evaluation on the Day of Baking]

The loaf bread produced using the hard wheat flour (Comparative Example 24) was less voluminous as compared with other loaf breads (Comparative Example 25, and Examples 39 and 40). The loaf bread produced using the full-fat soybean flour in place of 5% of the hard wheat flour (Comparative Example 25) had an unstably textured dough, and a large number of great pores were found. In addition, the odor of the soybean was sensed. The loaf breads produced using the full-fat soybean flour-containing composition in place of 5% of the hard wheat flour (Examples 39 and 40) had both richness and sweetness, and favorable smooth meltability in mouth. The loaf bread produced using the full-fat soybean flour-containing composition C in place of 5% of the hard wheat flour (Example 40) had a soft texture, whereas the loaf bread produced using the full-fat soybean flour-containing composition B in place of 5% of the hard wheat flour (Example 39) had a chewy/sticky texture. Thus, the two breads had different textures.

The loaf bread produced using the hard wheat flour (Comparative Example 24) was compared with the loaf bread produced using the full-fat soybean flour-containing composition B containing a potato starch as a plant starch, in place of 5% of the hard wheat flour (Example 39). The results are shown in Table 28.

TABLE 28

| | | | having | |
|---|---|---|---|---|
| | | having | highly | |
| | having airy | moist | crisp | having |
| | texture | texture | texture | richness |
| Comparative | 1/10 | 1/10 | 0/10 | 1/10 |
| Example 24 | panelists | panelists | panelists | panelists |
| Comparative | 3/10 | 2/10 | 1/10 | 4/10 |
| Example 24 | panelists | panelists | panelists | panelists |
| rather | | | | |
| preferred | | | | |
| neutral | 0/10 | 4/10 | 2/10 | 1/10 |
| | panelists | panelists | panelists | panelists |
| Example 39 | 5/10 | 3/10 | 5/10 | 1/10 |
| rather | panelists | panelists | panelists | panelists |
| preferred | | | | |
| Example 39 | 1/10 | 0/10 | 2/10 | 3/10 |
| | panelists | panelists | panelists | panelists |

It was revealed that by replacing a part of the hard wheat flour with the full-fat soybean flour-containing composition B, an airy and crisp texture was provided.

### [Evaluation on the Day After Baking]

The loaf bread produced using the hard wheat flour (Comparative Example 24) got dried and hardened, as compared with other loaf breads (Comparative Example 25, and Examples 39 and 40). In addition, a stuffy smell which seems to result from the wheat flour was generated. Moreover, a bitter taste from the wheat flour was also sensed, and the meltability in mouth was not smooth. Although the loaf bread produced using the full-fat soybean flour in place of 5% of the hard wheat flour (Comparative Example 25) had a moist texture, sensing of the odor of the soybean was enhanced as compared with the day before. The loaf bread produced using the full-fat soybean flour-containing composition C in place of 5% of the hard wheat flour (Example 40) had a moist texture and airy texture, and was hardly accompanied by odor(s) of the wheat and/or soybean. The loaf bread produced using the full-fat soybean flour-containing composition B in place of 5% of the hard wheat flour (Example 39) also had a moist texture and airy texture, and was hardly accompanied by odor(s) of the wheat and/or soybean, similarly.

The loaf bread produced using the hard wheat flour (Comparative Example 24) was compared with the loaf bread produced using the full-fat soybean flour-containing composition B containing a potato starch as a plant starch, in place of 5% of the hard wheat flour (Example 39). The results are shown in Table 29.

TABLE 29

| | | | having | |
|---|---|---|---|---|
| | | having | highly | |
| | having airy | moist | crisp | having good |
| | texture | texture | texture | flavor |
| Comparative | 2/10 | 1/10 | 0/10 | 1/10 |
| Example 24 | panelists | panelists | panelists | panelists |
| Comparative | 2/10 | 2/10 | 0/10 | 1/10 |
| Example 24 | panelists | panelists | panelists | panelists |
| rather | | | | |
| preferred | | | | |
| neutral | 0/10 | 2/10 | 1/10 | 3/10 |
| | panelists | panelists | panelists | panelists |
| Example 39 | 5/10 | 4/10 | 6/10 | 2/10 |
| rather | panelists | panelists | panelists | panelists |
| preferred | | | | |
| Example 39 | 1/10 | 1/10 | 3/10 | 3/10 |
| | panelists | panelists | panelists | panelists |

It was revealed that by replacing a part of the hard wheat flour with the full-fat soybean flour-containing composition B, the airy texture and the moist texture were maintained, and both the crisp texture and the flavor were improved even on the day after baking.

### Test Example 13

### Production Example 16

### Production Method of Udon (for Sensory Evaluation)

A basic ingredient mix A was stirred in a KENMIX mixer (trade name: KENMIX MAJOR, Aicohsha Manufacturing Co., Ltd.) with the setting of scale 1 for 1 min. During the stirring, an aqueous solution prepared by dissolving a dietary salt in water was added in small portions. The basic ingredient mix A was once scraped together with a spatula, and stirred as was with the setting of the lowest scale for 2 min. Next, the mix was placed into a plastic bag, and allowed to settle at ambient temperature for 1 hour. Thereafter, the mix was spread using a sheeter to give a thickness of 3 mm, and fold into three, and again fold into three. Then, the folded mix was placed into a plastic bag, and allowed to settle at ambient temperature for 15 min. Thereafter, the mix was spread using a sheeter to give a thickness of 1 mm, and cut into a width of about 3 mm using a pasta machine, followed by boiling in boiling water for 4 min to produce an udon for sensory evaluation. The recipe is shown in Table 30.

### Production Example 17

### Production Method of Udon (for Measuring Hardness)

A basic ingredient mix A was stirred in a KENMIX mixer (trade name: KENMIX MAJOR, Aicohsha Manufacturing Co., Ltd.) with the setting of scale 1 for 1 min. During the stirring, an aqueous solution prepared by dissolving a dietary salt in water was added in small portions. The basic ingredient mix A was once scraped together with a spatula, and stirred as was with the setting of the lowest scale for 2 min. Next, the mix was placed into a plastic bag, and allowed to settle at ambient temperature for 1 hour. Thereafter, the mix was spread using a sheeter to give a thickness of 3 mm, and fold into three, and again fold into three. Then, the folded mix was placed into a plastic bag, and allowed to settle at ambient temperature for 15 min. Thereafter, the mix was spread using a sheeter to give a thickness of 3 mm, and cut into a width of 3.0 cm, followed by allowing to settle at ambient temperature for 30 min. The strip was boiled in boiling water for 15 min, to produce an udon for measuring the hardness. The recipe is shown in Table 30.

TABLE 30

| | | blend (% by mass) | | | |
|---|---|---|---|---|---|
| | | Comparative | Comparative | | |
| component | | Example 26 | Example 27 | Example 41 | Example 42 |
| all-purpose flour | A | 66.7 | 63.3 | 63.3 | 63.3 |
| full-fat soybean | | — | 3.3 | — | — |
| flour | | | | | |
| full-fat soybean | | — | — | 3.3 | — |
| flour-containing | | | | | |
| composition B | | | | | |
| full-fat soybean | | — | — | — | 3.3 |
| flour-containing | | | | | |
| composition C | | | | | |
| dietary salt | | 3.3 | 3.3 | 3.3 | 3.3 |
| water | | 30.0 | 30.0 | 30.0 | 30.0 |

### Evaluation Method (11)

Sensory evaluation was made on the udon produced according to the method of Production Example 16 by eight expert panelists. Immediately after and one hour after the boiling, the udon was evaluated.

### Evaluation Method (12)

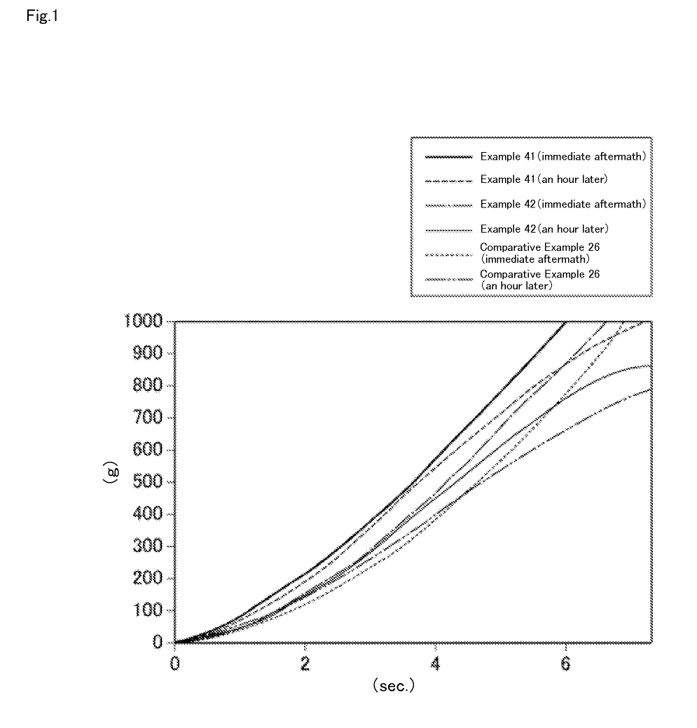

The hardness of the udon produced according to the method of Production Example 17 was measured. For the measurement, a rheometer (trade name: Texture Analyser TA. XT. Plus, manufactured by Stable Micro Systems Ltd.; plunger: tooth-shaped push rod) was used, and the hardness was measured under conditions of penetration speed: 5 cm/min; rupture strength. The sample was provided by cutting the strip having a width of 30 mm and a thickness of 3 mm into a length of 20 mm, and an average from three samples was determined. The results are shown in FIG. 1.

### Comparative Example 26

Udon was produced using an all-purpose flour. Measurement of sensory evaluation and hardness was carried out.

### Comparative Example 27

Udon was produced using a full-fat soybean flour (Full-fat Soybean Flour X) in place of 5% of the all-purpose flour. The sensory evaluation was carried out.

### Example 41

Udon was produced using the full-fat soybean flour-containing composition B produced according to the method of Production Example 13 in place of 5% of the all-purpose flour. The sensory evaluation and the measurement of the hardness were carried out.

### Example 42

Udon was produced using the full-fat soybean flour-containing composition C produced according to the method of Production Example 14 in place of 5% of the all-purpose flour. The sensory evaluation and the measurement of the hardness were carried out.

### [Sensory Evaluation]

The udon produced using the all-purpose flour (Comparative Example 26) was hard immediately after boiling, and had toughness/elasticity; however, it got soft and had diminished toughness/elasticity one hour after boiling. The udon produced using the full-fat soybean flour in place of 5% of the all-purpose flour (Comparative Example 27) was elastic immediately after the boiling, but strong odor of the soybean was sensed, had got hardened 1 hour after the boiling (distinct from the toughness/elasticity). The udon produced using the full-fat soybean flour-containing composition C in place of 5% of the all-purpose flour (Example 42) was hard immediately after the boiling, and had toughness/elasticity than the udon produced using the all-purpose flour (Comparative Example 26), and the toughness/elasticity was maintained even after 1 hour of the boiling. The udon produced using the full-fat soybean flour-containing composition B in place of 5% of the all-purpose flour (Example 41) had toughness/elasticity, and also had a chewy/sticky texture immediately after the boiling. Further, the toughness/elasticity was maintained even 1 hour after boiling.

The udon produced using the all-purpose flour (Comparative Example 26) was compared with the udon produced using the full-fat soybean flour-containing composition B containing a potato starch as a plant starch in place of 5% of the all-purpose flour (Example 41). The results are shown in Table 31.

TABLE 31

| | having | having |
|---|---|---|
| | chewy/sticky | toughness/ |
| | texture | elasticity |
| Comparative Example 26 | 2/8 panelists | 0/8 panelists |
| Comparative Example 26 | 1/8 panelists | 2/8 panelists |
| rather preferred | | |
| neutral | 1/8 panelists | 1/8 panelists |
| Example 41 rather | 4/8 panelists | 4/8 panelists |
| preferred | | |
| Example 41 | 0/8 panelists | 1/8 panelists |

It was revealed that by replacing a part of the all-purpose flour with the full-fat soybean flour-containing composition B, the udon having a chewy/sticky texture, and also having toughness/elasticity can be obtained.

### [Measurement of Hardness]

As is shown in FIG. 1, the udon produced using the full-fat soybean flour-containing composition in place of 5% of the all-purpose flour (Examples 41 and 42) was harder than the udon produced using the all-purpose flour (Comparative Example 26), and maintained the hardness even 1 hour after the boiling for 1 hrs.

### Test Example 14

### Production Example 18

### Production Method of Dashi-Maki Tamago (Rolled Egg with Dashi (Seasoning Stock))

A basic ingredient mix A was preliminarily mixed with dashi soup, and other ingredients were also added thereto and mixed well. The mixture was fried using a frying pan for tamagoyaki (rolled egg) according to a common procedure. Total amount of the mixture was 300 g. The recipe is shown in Table 32.

TABLE 32

| | | blend (% by mass) | | | |
|---|---|---|---|---|---|
| | | Comparative | Comparative | | |
| component | | Example 28 | Example 29 | Example 43 | Example 44 |
| whole egg | | 76.81 | 72.97 | 72.97 | 72.97 |
| hot water | dashi | 19.08 | 19.08 | 19.08 | 19.08 |
| seasoning | soup | 0.12 | 0.12 | 0.12 | 0.12 |
| stock | | | | | |
| dietary salt | | 0.38 | 0.38 | 0.38 | 0.38 |
| sweet cooking rice | | 2.88 | 2.88 | 2.88 | 2.88 |
| wine (mirin) | | | | | |
| light colored soy | | 0.72 | 0.72 | 0.72 | 0.72 |
| sauce | | | | | |
| full-fat | A | — | 1.27 | — | — |
| soybean flour | | | | | |
| egg substitute | | — | — | 1.27 | — |
| composition B | | | | | |
| egg substitute | | — | — | — | 1.27 |
| composition C | | | | | |
| water | | — | 2.57 | 2.57 | 2.57 |

### Evaluation Method (13)

Sensory evaluation was made on the dashi-maki tamago produced according to the method of Production Example 18 by eight expert panelists. The evaluation was made on the dashi-maki tamago 60 min after the frying, and after freezing and thawing.

### Comparative Example 28

Dashi-maki tamago was produced using eggs. The production method of the dashi-maki tamago conformed to that in Production Example 18.

### Comparative Example 29

Dashi-maki tamago was produced using the full-fat soybean flour (Full-fat Soybean Flour X) in place of 5% of the egg content. The production method of the dashi-maki tamago conformed to that in Production Example 18.

### Example 43

Dashi-maki tamago was produced using the egg substitute composition B produced according to the method of Production Example 6 in place of 5% of the egg content. The production method of the dashi-maki tamago conformed to that in Production Example 18.

### Example 44

Dashi-maki tamago was produced using the egg substitute composition C produced according to the method of Production Example 8 in place of 5% of the egg content. The production method of the dashi-maki tamago conformed to that in Production Example 18.

[Sixty Min after Frying]

The dashi-maki tamago produced using the egg (Comparative Example 28) was entirely hard, and water liberation was found. In addition, the dashi-maki tamago produced using the full-fat soybean flour in place of 5% of the egg content (Comparative Example 29) was moister than Comparative Example 28, but rather hard entirely, with water liberation found. To the contrary, the dashi-maki tamago produced using the full-fat soybean flour-containing composition C in place of 5% of the egg content (Example 44) had an elastic texture, and the dashi soup exuded upon biting, with less water liberation found. The dashi-maki tamago produced using the full-fat soybean flour-containing composition B in place of 5% of the egg content (Example 43) had an airy texture, and the dashi soup was held in the egg content, with less water liberation found.

The dashi-maki tamago produced using the egg (Comparative Example 28) was compared with the dashi-maki tamago produced using the full-fat soybean flour-containing composition B containing a potato starch as a plant starch in place of 5% of the egg content (Example 43). The results are shown in Table 33.

TABLE 33

| | | less water | |
|---|---|---|---|
| | | liberation | |
| | | caused, holding | comprehensively |
| | soft | dashi soup | favorable |
| Comparative | 1/8 panelists | 1/8 panelists | 0/8 panelists |
| Example 28 | | | |
| Comparative | 2/8 panelists | 2/8 panelists | 1/8 panelists |
| Example 28 | | | |
| rather | | | |
| preferred | | | |
| neutral | 0/8 panelists | 0/8 panelists | 1/8 panelists |
| Example 43 | 4/8 panelists | 5/8 panelists | 6/8 panelists |
| rather | | | |
| preferred | | | |
| Example 43 | 1/8 panelists | 0/8 panelists | 0/8 panelists |

It was revealed that by replacing a part of the egg content with the full-fat soybean flour-containing composition B, production of a soft dashi-maki tamago that held the dashi soup and was accompanied by less water liberation was enabled.

### [After Freezing and Thawing]

The dashi-maki tamago produced using the egg (Comparative Example 28) was the hardest, had a gritty texture, and accompanied by liberation of the dashi soup to provide a dehydrated texture. In addition, the dashi-maki tamago produced using the full-fat soybean flour in place of 5% of the egg content (Comparative Example 29) was moister than Comparative Example 28, but had a dehydrated texture. To the contrary, the dashi-maki tamago produced using the full-fat soybean flour-containing composition C in place of 5% of the egg content (Examples 43 and 44) had a smoother texture than the dashi-maki tamago produced using the egg (Comparative Example 28) and the dashi-maki tamago produced using the full-fat soybean flour in place of 5% of the egg content (Comparative Example 29), and exuding of the dashi soup occurred upon biting.

### Test Example 15

### Production Example 19

### Production Method of Rolled Cake

A basic ingredient mix A was beaten until it almost peaked. Subsequently, a basic ingredient mix B was well beaten until a whitish appearance was given. To the basic ingredient mix B which had been whipped previously was added the whipped basic ingredient mix A in three parts, and mixed so as not to collapse the foam. Thereto, was added a basic ingredient mix C which had been sieved beforehand, and mixed tenderly. The mixture was baked in an oven for 10 (upside temperature: 200° C./downside temperature: 190° C.). Whipped cream was spread over the cake, which was rolled to produce a rolled cake. The recipe is shown in Table 34.

TABLE 34

| | | blend (% by mass) | | | |
|---|---|---|---|---|---|
| | | Comparative | Comparative | | |
| component | | Example 30 | Example 31 | Example 45 | Example 46 |
| egg white | A | 40.6 | 40.6 | 40.6 | 40.6 |
| white superior soft | | 11.6 | 11.6 | 11.6 | 11.6 |
| sugar | | | | | |
| egg yolk | B | 17.4 | 17.4 | 17.4 | 17.4 |
| white superior soft | | 11.6 | 11.6 | 11.6 | 11.6 |
| sugar | | | | | |
| soft wheat flour | C | 18.8 | — | — | — |
| full-fat soybean | | — | 18.8 | — | — |
| flour | | | | | |
| full-fat soybean | | — | — | 18.8 | — |
| flour-containing | | | | | |
| composition B | | | | | |
| full-fat soybean | | — | — | — | 18.8 |
| flour-containing | | | | | |
| composition C | | | | | |

### Evaluation Method (14)

Sensory evaluation was made on the rolled cake produced according to the method of Production Example 19 by ten expert panelists. Further, with respect to the flavor and texture, each item was evaluated on a scale of one to five, and the average of the values was determined.

### Comparative Example 30

A rolled cake was produced using soft wheat flour. The production method of the rolled cake conformed to that in Production Example 19.

### Comparative Example 31

A rolled cake was produced using the full-fat soybean flour (Full-fat Soybean Flour X) in place of the soft wheat flour. The production method of the rolled cake conformed to that in Production Example 19.

### Example 45

A rolled cake was produced using the full-fat soybean flour-containing composition B produced according to the method of Production Example 13 in place of the soft wheat flour. The production method of the rolled cake conformed to that in Production Example 19.

### Example 46

A rolled cake was produced using the full-fat soybean flour-containing composition C produced according to the method of Production Example 14 in place of the soft wheat flour. The production method of the rolled cake conformed to that in Production Example 19.

The rolled cake produced using soft wheat flour (Comparative Example 30) had an airy texture and was creamy, but had a strong smell of eggs, and a desiccated texture. The rolled cake produced using the full-fat soybean flour in place of the soft wheat flour (Comparative Example 31) had a dense structure and strong sweetness, and was moist. The rolled cake produced using the full-fat soybean flour-containing composition C in place of the soft wheat flour (Example 46) had reduced heavy savor of the egg, while having richness and sweetness, and improved flavor than Comparative Example 30 and Comparative Example 31. Furthermore, airy texture, and smooth meltability in mouth were provided. The rolled cake produced using the full-fat soybean flour-containing composition B in place of the soft wheat flour (Example 45) had spicy and sweet flavor as well as reduced heavy savor of the egg, while having richness and sweetness, and improved flavor than Example 46. Furthermore, an airy texture and moist texture, as well as smooth meltability in mouth were provided.

The rolled cake was produced using soft wheat flour (Comparative Example 30) was compared with the rolled cake produced using the full-fat soybean flour-containing composition B in place of the soft wheat flour (Example 45). The results are shown in Table 35.

TABLE 35

| | having airy | having moist | having good |
|---|---|---|---|
| | texture | texture | flavor |
| Comparative | average | average | average |
| Example 30 | 3.5 | 3.1 | 3.6 |
| Example 45 | average | average | average |
| | 2.9 | 3.4 | 3.8 |

It was revealed that by replacing the soft wheat flour with the full-fat soybean flour-containing composition B, production of a rolled cake having a moist texture and a good flavor was enabled.

### Test Example 16

### Production Example 20

### Production Method of Deep-Fried Soybean Confectionery

Powders were mixed. Then, to the mixture was added water in small portions while stirring with a KENMIX mixer (trade name: KENMIX MAJOR, Aicohsha Manufacturing Co., Ltd.). After assembling to one block followed by sealing tight, aging was carried out in a refrigerator for 1 hour. Thereafter, the dough was spread with a sheeter to have a thickness of 0.75 mm, and cut to shape to have a size of 3 cm×3 cm. The formed piece was deep-fried in oil at 170° C. for 4 min to produce a deep-fried soybean confectionery. The recipe is shown in Table 36.

TABLE 36

blend (% by mass)

| component | Example 47 | Example 48 |
|---|---|---|
| full-fat soybean | 52.8 | — |
| flour-containing | | |
| composition B | | |
| full-fat soybean | — | 52.8 |
| flour-containing | | |
| composition C | | |
| potato starch | 14.6 | 14.6 |
| (etherified starch) | | |
| dietary salt | 1.0 | 1.0 |
| soft brown sugar | 2.0 | 2.0 |
| water | 29.7 | 29.7 |

potato starch: FARINEX AG600, Matsutani Chemical Industry Co., Ltd.

### Evaluation Method (15)

Sensory evaluation (appearance, flavor and texture) was made on the deep-fried soybean confectionery produced according to the method of Production Example 20 by ten expert panelists.

### Example 47

A deep-fried soybean confectionery was produced using the full-fat soybean flour-containing composition B produced according to the method of Production Example 13 as a principal basic ingredient. The production method of the deep-fried soybean confectionery conformed to that in Production Example 20.

### Example 48

A deep-fried soybean confectionery was produced using the full-fat soybean flour-containing composition C produced according to the method of Production Example 14 as a principal basic ingredient. The production method of the deep-fried soybean confectionery conformed to that in Production Example 20.

The deep-fried soybean confectionery produced using the full-fat soybean flour-containing composition B as a principal basic ingredient (Example 47), and the deep-fried soybean confectionery produced using the full-fat soybean flour-containing composition C as a principal basic ingredient (Example 48) both had favorable flavor, texture and aftertaste, and proven that they are suited as a principal basic ingredient of deep-fried confectioneries.

### Test Example 17

### Study of Emulsifying Agent (1)

### Production Example 21

### Production Method of Full-Fat Soybean Flour-Containing Composition D

A full-fat soybean flour-containing composition D was obtained by mixing 70.4 parts by mass of a full-fat soybean flour (Full-fat Soybean Flour X: Nisshin OilliO Group, Ltd.), 3.0 parts by mass of a soybean protein (Solpea 4000: Nisshin OilliO Group, Ltd.), 5.0 parts by mass of a soybean protein (Soya flour FT-N: Nisshin OilliO Group, Ltd.), 1.0 parts by mass of an emulsifying agent (POEM B-10: Riken Vitamin Co., Ltd.), 1.4 parts by mass of an emulsifying agent (RYOTO Sugar Ester S-1170: Mitsubishi-Kagaku Foods Corporation), 9.5 parts by mass of trehalose (TREHA: Hayashibara Shoji, Inc.) as a masking agent, 2.0 parts by mass of a highly branched cyclic dextrin (Cluster Dextrin: Glico Foods Co., Ltd.) as a masking agent and 7.6 parts by mass of a tapioca starch (Matsutani Bara: Matsutani Chemical Industry Co., Ltd.; acetylated and crosslinked) as a plant starch. The recipe (denoted based on % by mass) is shown in Table 37.

TABLE 37

| | full-fat soybean |
|---|---|
| | flour-containing |
| % by mass | composition D |
| full-fat soybean flour | 70.4 |
| soybean protein | 8.0 |
| emulsifying agent 1 | 1.0 |
| emulsifying agent 2 | 1.4 |
| masking agent | 11.5 |
| plant starch | 7.6 |

emulsifying agent 1: POEM B-10 (manufactured by Riken Vitamin Co., Ltd.)
emulsifying agent 2: RYOTO Sugar Ester D-1170 (manufactured by Mitsubishi-Kagaku Foods Corporation)
plant starch: tapioca starch (Matsutani Bara: Matsutani Chemical Industry Co., Ltd., acetylated and crosslinked)

### Evaluation Method (16)

Sensory evaluation (appearance, flavor and texture) was made on the pound cake produced according to the method of Production Example 3 by five expert panelists.

### Example 49

A pound cake was produced using the full-fat soybean flour-containing composition D produced according to the method of Production Example 21. The production method of the pound cake conformed to that in Production Example 3. For blending, the recipe shown in Table 9 was employed by replacing the egg substitute composition with the full-fat soybean flour-containing composition D.

The pound cake produced using the full-fat soybean flour-containing composition D containing RYOTO Sugar Ester S-1170 (sucrose fatty acid ester: monoester 55%, di-, tri-, polyester 45%; HLB value: 11) as the emulsifying agent (Example 49) had an airy texture, smooth meltability in mouth, and a mild flavor.

### Test Example 18

### Study of Emulsifying Agent (2)

### Example 50

A loaf bread was produced using the full-fat soybean flour-containing composition D produced according to the method of Production Example 21. The production method of the loaf bread conformed to that in Production Example 15. For blending, a similar recipe shown in Table 27 was employed which includes the full-fat soybean flour-containing composition.

### Evaluation Method (17)

Sensory evaluation (appearance, flavor and texture) was made on the loaf bread produced according to the method of Production Example 15 by five expert panelists.

The loaf bread produced using the full-fat soybean flour-containing composition D containing RYOTO Sugar Ester S-1170 (sucrose fatty acid ester: monoester 55%, di-, tri-, polyester 45%; HLB value: 11) as the emulsifying agent (Example 50) exhibited satisfactory leavening, was soft, and had a favorable flavor.

### Test Example 19

### Study of Emulsifying Agent (3)

### Example 51

A steamed bread was produced using the full-fat soybean flour-containing composition D produced according to the method of Production Example 21. The production method of the steamed bread conformed to that in Production Example 12. For blending, a similar recipe shown in Table 23 was employed which includes the full-fat soybean flour-containing composition.

### Evaluation Method (18)

Sensory evaluation (appearance, flavor and texture) was made on the steamed bread produced according to the method of Production Example 12 by five expert panelists.

The steamed bread produced using the full-fat soybean flour-containing composition D containing RYOTO Sugar Ester S-1170 (sucrose fatty acid ester: monoester 55%, di-, tri-, polyester 45%; HLB value: 11) as the emulsifying agent (Example 51) exhibited satisfactory leavening, was creamy, and had smooth meltability in mouth and a light texture.

What is claimed is:

1. A full-fat soybean flour-containing composition comprising a full-fat soybean flour, a plant protein, an emulsifying agent, and a masking agent.

2. The full-fat soybean flour-containing composition according to claim 1, wherein the plant protein is at least one selected from the group consisting of a wheat protein and a soybean protein.

3. The full-fat soybean flour-containing composition according to claim 1, wherein the content of the emulsifying agent in the full-fat soybean flour-containing composition is no less than 1% by mass and less than 5% by mass, and the content of the masking agent is greater than 1.5% by mass and no greater than 20% by mass.

4. The full-fat soybean flour-containing composition according to claim 1, wherein the component contained in the largest amount in the full-fat soybean flour-containing composition is the full-fat soybean flour.

5. The full-fat soybean flour-containing composition according to claim 1, wherein the content of the full-fat soybean flour in the full-fat soybean flour-containing composition is 40 to 90% by mass.

6. The full-fat soybean flour-containing composition according to claim 1, wherein the total content of the full-fat soybean flour and the plant protein in the full-fat soybean flour-containing composition is 65 to 97% by mass.

7. The full-fat soybean flour-containing composition according to claim 1, further comprising at least one selected from the group consisting of a plant starch and a rice flour.

8. The full-fat soybean flour-containing composition according to claim 7, wherein the content of the at least one selected from the group consisting of the plant starch and the rice flour in the full-fat soybean flour-containing composition is no greater than 30% by mass.

9. The full-fat soybean flour-containing composition according to claim 7, wherein the total content of the full-fat soybean flour, the plant protein, and the at least one selected from the group consisting of the plant starch and the rice flour in the full-fat soybean flour-containing composition is 70 to 95% by mass.

10. A food prepared using the full-fat soybean flour-containing composition according to claim 1.

11. The food according to claim 10, wherein the food is one selected from the group consisting of a baked food, a fried-in-oil food, a steamed food, a noodle strip food, a gelatinous fresh confectionery, a tamagoyaki, a flour for tempura, and a batter.

12. The food according to claim 10, wherein the food is a rolled cake not containing any of a wheat flour and milk.

13. The food according to claim 10, wherein the food is a deep-fried confectionery not containing any of a wheat flour, milk and egg.

14. An egg substitute composition comprising a full-fat soybean flour, a plant protein, an emulsifying agent, and a masking agent.

15. The egg substitute composition according to claim 14, wherein the plant protein is at least one selected from the group consisting of a wheat protein and a soybean protein.

16. The egg substitute composition according to claim 14, wherein the content of the emulsifying agent in the egg substitute composition is no less than 1% by mass and less than 5% by mass, and the content of the masking agent is greater than 1.5% by mass and no greater than 20% by mass.

17. The egg substitute composition according to claim 14, wherein the component contained in the largest amount in the egg substitute composition is the full-fat soybean flour.

18. The egg substitute composition according to claim 14, wherein the content of the full-fat soybean flour in the egg substitute composition is 40 to 90% by mass.

19. The egg substitute composition according to claim 14, wherein the total content of the full-fat soybean flour and the plant protein in the egg substitute composition is 65 to 97% by mass.

20. The egg substitute composition according to claim 14, further comprising at least one selected from the group consisting of a plant starch and a rice flour.

21. The egg substitute composition according to the claim 20, wherein the content of the at least one selected from the group consisting of the plant starch and the rice flour in the egg substitute composition is no greater than 30% by mass.

22. The egg substitute composition according to claim 20, wherein the total content of the full-fat soybean flour, the plant protein, and the at least one selected from the group consisting of the plant starch and the rice flour in the egg substitute composition is 70 to 95% by mass.

23. A food prepared using the egg substitute composition according to claim 14.

24. The food according to claim 23, wherein the food is one selected from the group consisting of a baked food, a fried-in-oil food, a steamed food, a gelatinous fresh confectionery, a tamagoyaki, and a batter.

25. The food according to claim 23, wherein the food is one selected from the group consisting of a baked food, a fried-in-oil food, a steamed food, a gelatinous fresh confectionery and a batter, and does not contain egg.

26. The food according to claim 23, wherein the food is a steamed bread not containing any of egg, a wheat flour and milk.
